(19) United States
(12) Patent Application Publication
(10) Pub. No.: US 2025/0129829 A1
(43) Pub. Date: Apr. 24, 2025

(54) PAD CLIP FOR DISC BRAKE DEVICE AND DISC BRAKE DEVICE

(71) Applicant: AKEBONO BRAKE INDUSTRY CO., LTD., Tokyo (JP)

(72) Inventor: Haruki IWAI, Tokyo (JP)

(73) Assignee: AKEBONO BRAKE INDUSTRY CO., LTD., Tokyo (JP)

(21) Appl. No.: 18/922,875

(22) Filed: Oct. 22, 2024

(30) Foreign Application Priority Data
Oct. 24, 2023 (JP) 2023-182528

(51) Int. Cl. F16D 65/097; F16D 55/225

(52) U.S. Cl. CPC F16D 65/0978; F16D 55/225; F16D 2200/0021

(57) ABSTRACT

A pad clip for a disc brake device includes a main body portion elastically supported between a central bridge and an end bridge; and a pair of pad pressing portions configured to press outer circumferential edge portions of a pair of pads toward a radially inner side. A radially outer side surface of the main body portion is configured to be pressed against a radially inner side surface of a circumferential bridge by an elastic force of the pair of pad pressing portions.

### CROSS-REFERENCE TO RELATED APPLICATIONS

This application is based on and claims priority under 35 USC § 119 from Japanese Patent Application No. 2023-182528 filed on Oct. 24, 2023, the contents of which are incorporated herein by reference.

### TECHNICAL FIELD

The present disclosure relates to a pad clip for a disc brake device and a disc brake device.

### BACKGROUND

Disc brake devices are widely used for braking automobiles and motorcycles. During braking by the disc brake device, a pair of pads disposed on both sides of a rotor rotating together with a wheel are pressed against both side surfaces of the rotor in an axial direction by a piston.

There are disc brake devices having various structures in the related art, but since an opposed piston type disc brake device including pistons on both sides of a rotor in an axial direction can obtain a stable braking force, usage examples have been increased in recent years.

For example, as described in JP2010-78055A, an opposed piston type disc brake device includes a caliper disposed to cover a rotor that rotates together with a wheel from a radially outer side and fixed to a vehicle body, and a pair of pads supported in a manner of being movable in an axial direction with respect to the caliper and disposed on both sides of the rotor in the axial direction.

The caliper includes: an inner body; an outer body; a rotation-in side end bridge and a rotation-out side end bridge which are disposed on a radially outer side of an outer circumferential edge of the rotor and connect end portions on both sides of each of the inner body and the outer body in the circumferential direction; and a central bridge which is disposed on the radially outer side of the outer circumferential edge of the rotor and connects a circumferential central portion of the inner body and a circumferential central portion of the outer body in an axial direction.

The inner body includes an inner cylinder, and an inner piston is fitted to the inner cylinder. The outer body has an outer cylinder, and an outer piston is fitted to the outer cylinder.

During braking, brake oil is fed from a master cylinder into each of the inner cylinder and the outer cylinder. Accordingly, the inner piston fitted to the inner cylinder is pushed out in the axial direction, and the pad supported by the inner body is pressed against the side surface of the rotor in the axial direction. Similarly, the outer piston fitted to the outer cylinder is pushed out in the axial direction, and the pad supported by the outer body is pressed against the side surface of the rotor in the axial direction. As a result, the rotor is more strongly clamped by the pair of pads, and the vehicle is braked.

During braking, the inner piston and the outer piston apply forces to the inner body and the outer body in directions away from each other in the axial direction as a reaction to press the pair of pads against both side surfaces of the rotor in the axial direction. Therefore, when rigidity of the caliper is not sufficient, the inner body and the outer body are elastically deformed in directions away from each other in the axial direction, and a braking feeling may be deteriorated due to an increase in consumption of the fluid.

On the one hand, since the disc brake device is provided on a road surface side with respect to a spring forming a suspension device in the vehicle, the disc brake device has a so-called unsprung load. Therefore, there is a demand for weight reduction in order to improve fuel efficiency and driving performance of a vehicle.
Patent Literature 1: JP2010-78055A
Patent Literature 2: US2013/0092481A1

US2013/0092481A1 describes a structure in which a circumferential bridge is hung between an end bridge and a central bridge in a circumferential direction in order to achieve both securing rigidity and weight reduction of a disc brake device.

In the disc brake device, a pad clip is provided between the end bridge and the central bridge to prevent a pad from rattling during non-braking. However, it is difficult to apply, to the disc brake device including the circumferential bridge, the pad clip that is incorporated into the disc brake device in the related art without a circumferential bridge in the original form thereof since an interference occurs between the circumferential bridge and the pad clip.

An object of the present disclosure is to provide a pad clip that can be applied to a disc brake device including a circumferential bridge and can stably apply a pressing force to a pair of pads.

### SUMMARY

A pad clip for a disc brake device according to an aspect of the present disclosure is made of a metal plate, and is configured to elastically press a pair of pads and configured to be attached to a caliper including an inner body, an outer body, a central bridge and an end bridge which are disposed apart from each other in a circumferential direction and which respectively connect the inner body and the outer body in an axial direction, and a circumferential bridge which is hung between the central bridge and the end bridge in the circumferential direction.

The pad clip for a disc brake device according to the aspect of the present disclosure includes: a main body portion elastically supported between the central bridge and the end bridge; and a pair of pad pressing portions configured to press outer circumferential edge portions of the pair of pads toward a radially inner side.

A radially outer side surface of the main body portion is configured to be pressed against a radially inner side surface of the circumferential bridge by an elastic force of the pair of pad pressing portions.

In the pad clip for the disc brake device according to the aspect of the present disclosure, the main body portion includes, at an end portion on one side in a circumferential direction, two first fixing portions configured to press, in the circumferential direction, portions located on both sides with a connection portion with the circumferential bridge sandwiched in relation to the axial direction, of a side surface of the central bridge on the other side in a circumferential direction, and at an end portion on the other side in the circumferential direction, a second fixing portion configured to directly or indirectly press, in the circumferential direction, a portion located at the radially inner side of the connection portion with the circumferential bridge, of a side surface of the end bridge on the one side in the circumferential direction.

In the pad clip for the disc brake device according to the aspect of the present disclosure, the pair of pad pressing portions are disposed on both sides of the main body portion in relation to the axial direction, and each have a lateral U-shape when viewed in the circumferential direction.

The pad clip for the disc brake device according to the aspect of the present disclosure further includes a first clip including the main body portion and the pair of pad pressing portions; and a second clip configured to be assembled to the end bridge.

The second clip includes an interposed portion configured to be disposed between the second fixing portion and the side surface of the end bridge on the one side in the circumferential direction.

The interposed portion includes a radial engagement portion configured to be engaged with the second fixing portion in a radial direction.

When the pad clip for the disc brake device according to the aspect of the present disclosure includes the first clip and the second clip, the second fixing portion has a shape bent to be convex on the other side in the circumferential direction, the radial engagement portion has a shape bent to be convex on the one side in the circumferential direction, and the second fixing portion is disposed on a radially outer side the radial engagement portion.

In the pad clip for the disc brake device according to the aspect of the present disclosure, the second clip is configured to be assembled to the end bridge on a rotation-out side, and includes two outer side clamping portions and one inner side clamping portion that are configured to elastically clamp the end bridge from both sides in the radial direction.

The outer side clamping portions each have a flat plate shape, are configured to be disposed on both sides of the circumferential bridge in relation to the axial direction, and are configured to be clamped between a radially outer side surface of the end bridge and the pad.

When the second clip has two outer side clamping portions and one inner side clamping portion, the inner side clamping portion includes, at a portion protruding to the other side in the circumferential direction from the outer side clamping portions, a circumferential engagement portion that is bent to be convex on the radially outer side and that is configured to be engaged with a radially inner side surface of the end bridge in the circumferential direction.

When the pad clip for the disc brake device according to the aspect of the present disclosure includes the first clip and the second clip, the second clip includes a pair of second axial restriction portions configured to be disposed to closely face both side surfaces of the circumferential bridge in the axial direction.

When the pad clip for the disc brake device according to the aspect of the present disclosure includes the first clip and the second clip, the second clip has a width in the axial direction slightly larger than a width of the second fixing portion in the axial direction, and has an axial engagement portion configured to be engaged with the second fixing portion in the axial direction.

When the pad clip for the disc brake device according to the aspect of the present disclosure includes the first clip and the second clip, the first clip includes a pair of first axial restriction portions configured to be disposed to closely face both side surfaces of the circumferential bridge in the axial direction.

When the pad clip for the disc brake device according to the aspect of the present disclosure includes the first clip and the second clip, the first clip includes a radial restriction portion that is configured to abut against the radially inner side surface of the circumferential bridge to prevent an abutting position of each of the first fixing portions with respect to the side surface of the central bridge on the other side in the circumferential direction from being displaced toward the radially outer side from a normal position, when the first clip is assembled to the caliper.

In the pad clip for the disc brake device according to the aspect of the present disclosure, the pair of pad pressing portions are configured to press the pads in a direction away from a rotor in the axial direction.

A disc brake device according to an aspect of the present disclosure includes a caliper, a pair of pads, and a pad clip made of a metal plate.

The caliper includes an inner body and an outer body disposed on both sides in an axial direction with a rotor sandwiched, a central bridge and an end bridge which are disposed apart from each other in a circumferential direction and which respectively connect the inner body and the outer body in the axial direction, and a circumferential bridge which is hung between the central bridge and the end bridge in the circumferential direction.

The pair of pads are supported in a manner of being movable in the axial direction with respect to the caliper.

The pad clip is configured to elastically press the pair of pads, is attached to the caliper, and is the pad clip for the disc brake device according to the aspect of the present disclosure.

In the disc brake device according to the aspect of the present disclosure, the inner side clamping portion of the pad clip includes, at a portion protruding to the other side in the circumferential direction from the outer side clamping portions, a circumferential engagement portion that is bent to be convex on the radially outer side and that is engaged with a radially inner side surface of the end bridge in the circumferential direction, and the end bridge has, on the radially inner side surface, an engagement inclination surface that is inclined in a direction toward the radially inner side as approaching one side in a circumferential direction and that is engaged with the circumferential engagement portion in the circumferential direction.

In the disc brake device according to the aspect of the present disclosure, the end bridge has a planar moment supporting surface configured to be in surface contact with the outer side clamping portions on the radially outer side surface, and an inclination angle of the engagement inclination surface with respect to the moment supporting surface is 15 degrees or more and 30 degrees or less.

In the disc brake device according to the aspect of the present disclosure, the main body portion of the pad clip includes the two first fixing portion and the one second fixing portion, a second fixing portion is configured to directly press, in the circumferential direction, a portion located on a radially inner side of a connection portion with the circumferential bridge, of a side surface of the end bridge on one side in a circumferential direction, and the end bridge has an engagement recessed portion recessed toward the other side in a circumferential direction at a portion configured to be pressed by the second fixing portion, of the side surface on the one side in the circumferential direction.

In the disc brake device according to the aspect of the present disclosure, a side surface of the central bridge on the other side in a circumferential direction has, at a radially inner side portion, a first inclination surface that is inclined in a direction toward the other side in the circumferential direction as approaching a radially outer side, and has, at a portion adjacent to the radially outer side of the first inclination surface, a second inclination surface that is inclined in a direction toward one side in a circumferential direction as approaching the radially outer side.

### BRIEF DESCRIPTION OF DRAWINGS

FIG. 1 is a front view illustrating a disc brake device to which a rotation-out side pad clip according to a first embodiment of the present disclosure is attached.

FIG. 2 is an upper side view of FIG. 1.

FIG. 3 is a lower side view of FIG. 1.

FIG. 4 is a perspective view of the disc brake device to which the rotation-out side pad clip according to the first embodiment of the present disclosure is attached, as viewed from a radially outer side and the other side in a circumferential direction.

FIG. 5 is a perspective view of the disc brake device to which the rotation-out side pad clip according to the first embodiment of the present disclosure is attached, as viewed from the radially outer side and one side in a circumferential direction.

FIG. 6 is a cross-sectional view taken along a line A-A in FIG. 2.

FIG. 7 is a cross-sectional view taken along a line B-B in FIG. 2.

FIG. 8 is an enlarged view of a portion on the other side in the circumferential direction of FIG. 2.

FIG. 9 is an enlarged view of a portion on the one side in the circumferential direction portion of FIG. 2.

FIG. 10 is an enlarged view of the portion on the other side in the circumferential direction of FIG. 6.

FIG. 11 is an enlarged view of the portion on the other side in the circumferential direction of FIG. 7.

FIG. 12 is a diagram in which the pads are omitted from FIG. 2.

FIG. 13 is a diagram in which the pads are omitted from FIG. 3.

FIG. 14 is a diagram in which the pads are omitted from FIG. 6.

FIG. 15 is a diagram in which the pads are omitted from FIG. 7.

FIG. 16 is an enlarged view of the portion on the other side in the circumferential direction of FIG. 13.

FIG. 17 is an enlarged view of the portion on the other side in the circumferential direction of FIG. 14.

FIG. 18 is an enlarged view of the portion on the other side in the circumferential direction of FIG. 15.

FIG. 19 is a cross-sectional view taken along a line C-C in FIG. 12.

FIG. 20 is a front view illustrating the rotation-out side pad clip according to the first embodiment of the present disclosure.

FIG. 21 is a view of the rotation-out side pad clip according to the first embodiment as viewed from an upper side in FIG. 20.

FIG. 22 is a view of the rotation-out side pad clip according to the first embodiment as viewed from a lower side in FIG. 20.

FIG. 23 is a view of the rotation-out side pad clip according to the first embodiment as viewed from a right side in FIG. 20.

FIG. 24 is a view of the rotation-out side pad clip according to the first embodiment as viewed from a left side in FIG. 20.

FIG. 25 is a perspective view of the rotation-out side pad clip according to the first embodiment as viewed from a radially outer side (upper side).

FIG. 26 is a perspective view of the rotation-out side pad clip according to the first embodiment as viewed from a radially inner side (lower side).

FIG. 27 is a front view in which a first clip forming the rotation-out side pad clip according to the first embodiment of the present disclosure is extracted.

FIG. 28 is a view of the first clip forming the rotation-out side pad clip according to the first embodiment as viewed from an upper side in FIG. 27.

FIG. 29 is a view of the first clip forming the rotation-out side pad clip according to the first embodiment as viewed from a lower side in FIG. 27.

FIG. 30 is a view of the first clip forming the rotation-out side pad clip according to the first embodiment as viewed from a right side in FIG. 27.

FIG. 31 is a view of the first clip forming the rotation-out side pad clip according to the first embodiment as viewed from a left side in FIG. 27.

FIG. 32 is a perspective view of the first clip forming the rotation-out side pad clip according to the first embodiment as viewed from the radially outer side (upper side).

FIG. 33 is a perspective view of the first clip forming the rotation-out side pad clip according to the first embodiment as viewed from the radially inner side (lower side).

FIG. 34 is a front view in which a second clip forming the rotation-out side pad clip according to the first embodiment of the present disclosure is extracted.

FIG. 35 is a view of the second clip forming the rotation-out side pad clip according to the first embodiment as viewed from an upper side in FIG. 34.

FIG. 36 is a view of the second clip forming the rotation-out side pad clip according to the first embodiment as viewed from a lower side in FIG. 34.

FIG. 37 is a view of the second clip forming the rotation-out side pad clip according to the first embodiment as viewed from a right side in FIG. 34.

FIG. 38 is a view of the second clip forming the rotation-out side pad clip according to the first embodiment as viewed from a left side in FIG. 34.

FIG. 39 is a perspective view of the second clip forming the rotation-out side pad clip according to the first embodiment as viewed from the radially outer side (upper side).

FIG. 40 is a perspective view of the second clip forming the rotation-out side pad clip according to the first embodiment as viewed from the radially inner side (lower side).

FIG. 41 is a cross-sectional view for illustrating prevention of an inclination of the rotation-out side pad clip according to the first embodiment.

FIG. 42 is a front view in which a rotation-in side pad clip incorporated in the disc brake device according to the first embodiment is extracted.

FIG. 43 is an upper side view of FIG. 42.

FIG. 44 is a lower side view of FIG. 42.

FIG. 45 is a left side view of FIG. 42.

FIG. 46 is a perspective view in which the rotation-in side pad clip incorporated in the disc brake device according to the first embodiment is extracted.

FIG. 47 is a view corresponding to FIG. 10, illustrating a disc brake device to which a rotation-out side pad clip according to a second embodiment of the present disclosure is attached.

### DESCRIPTION OF EMBODIMENTS

### First Embodiment

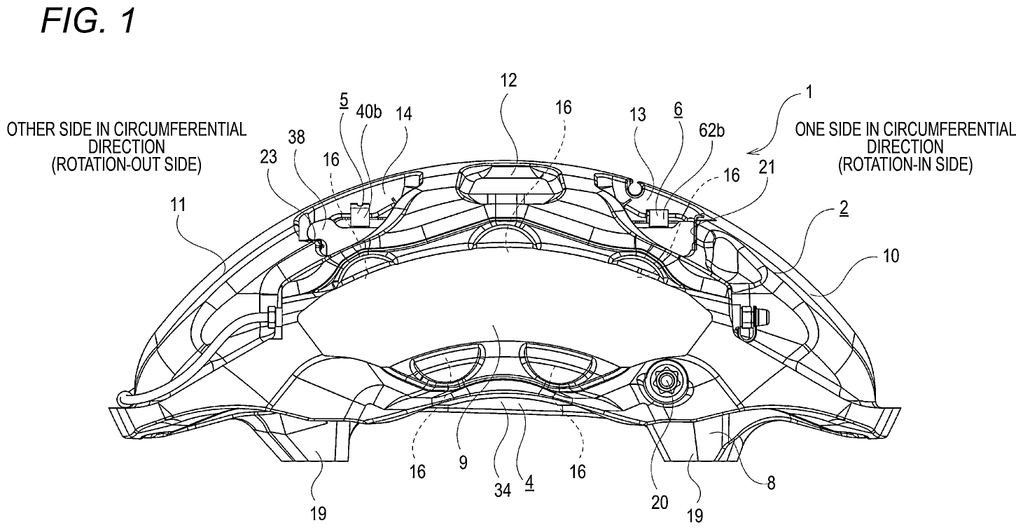

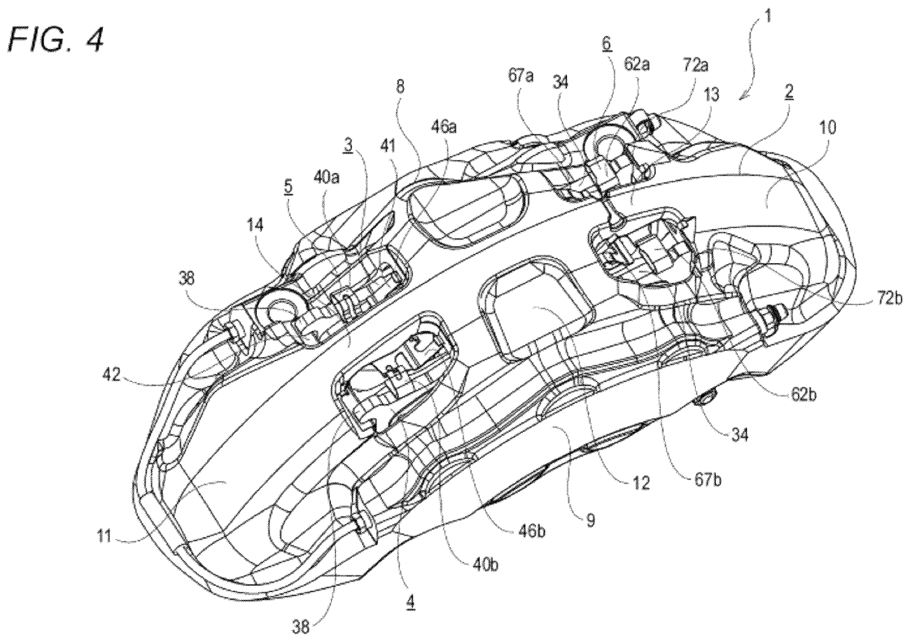

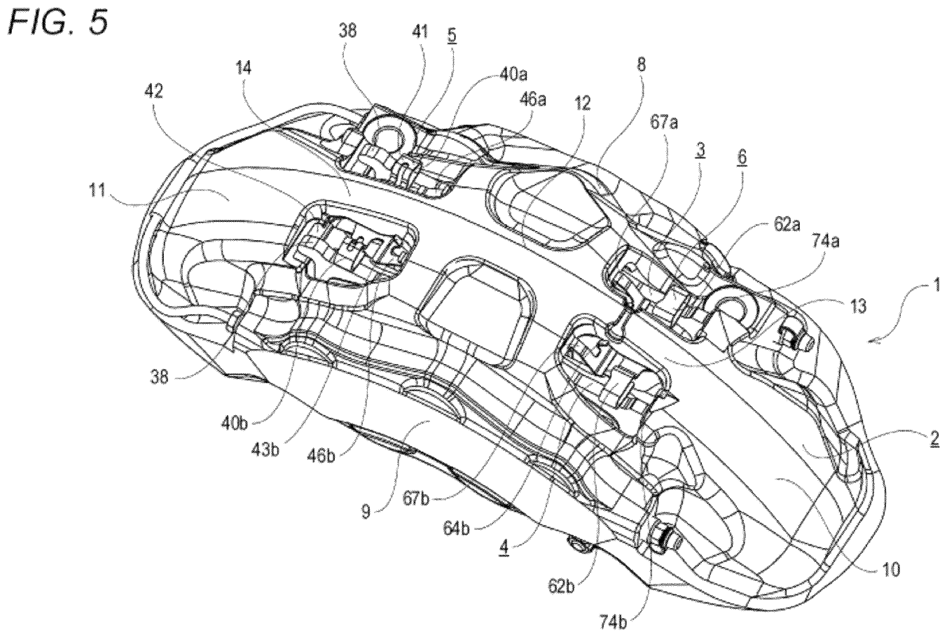

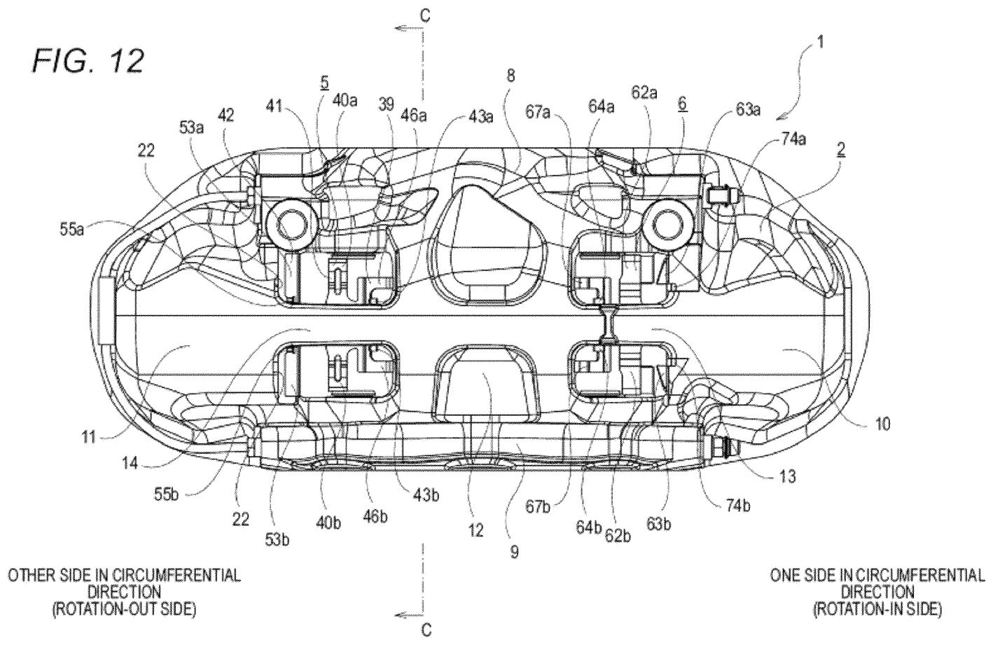

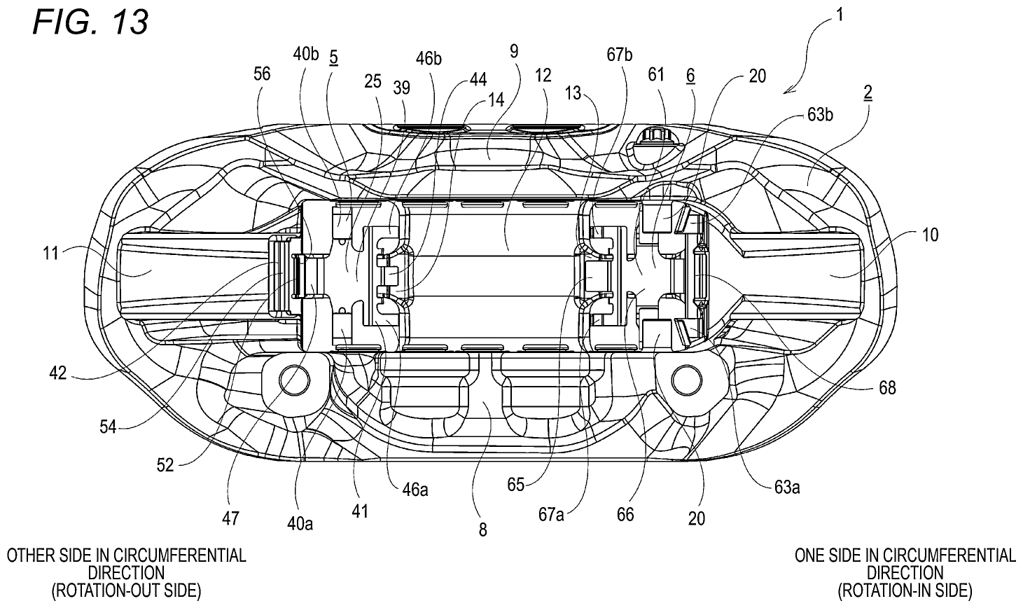

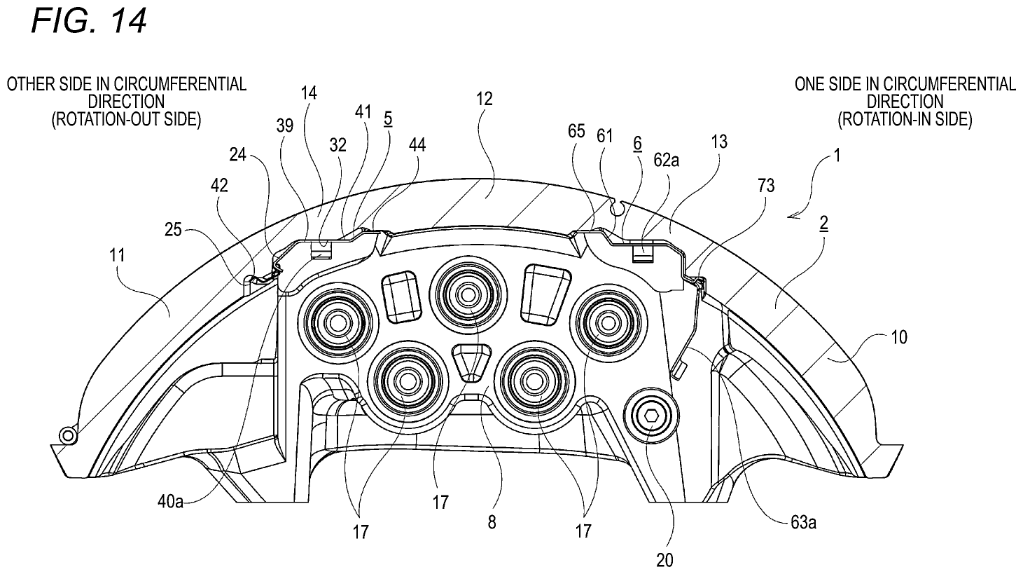

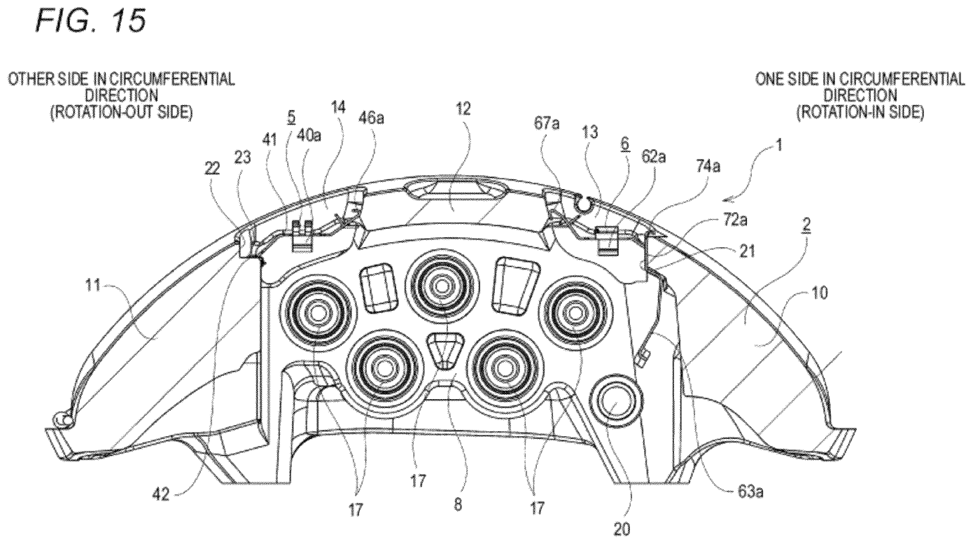

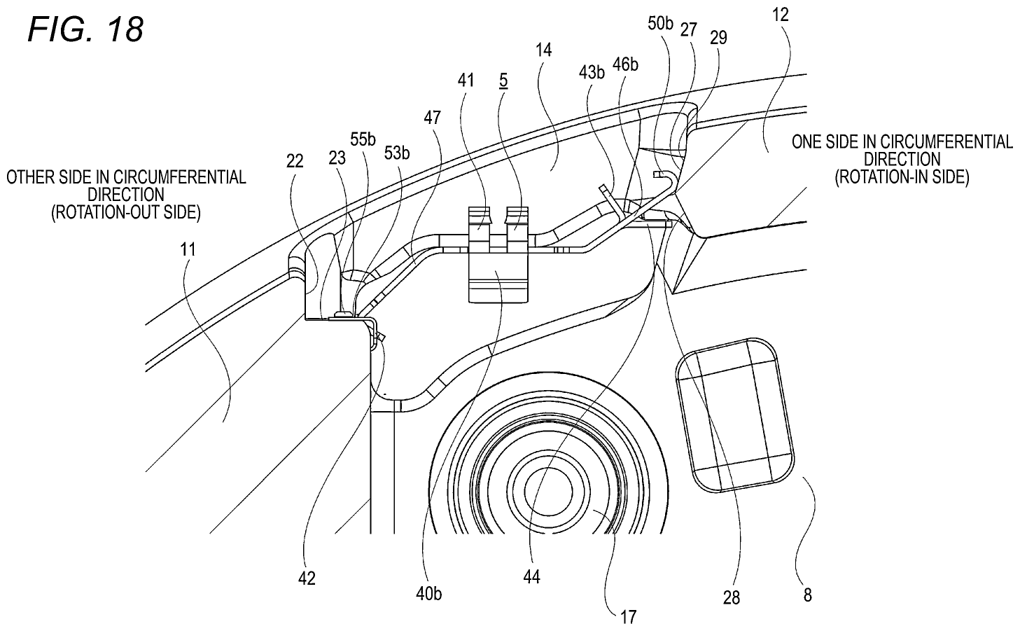

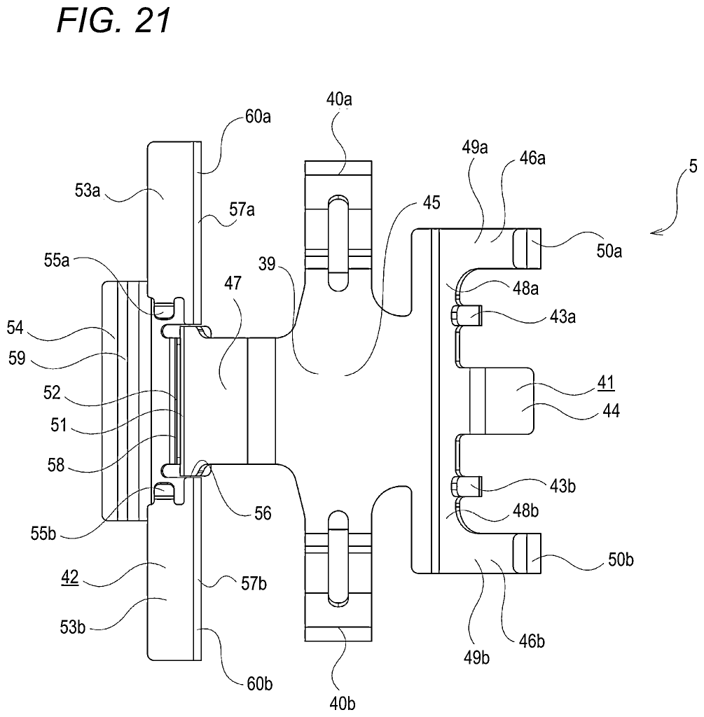

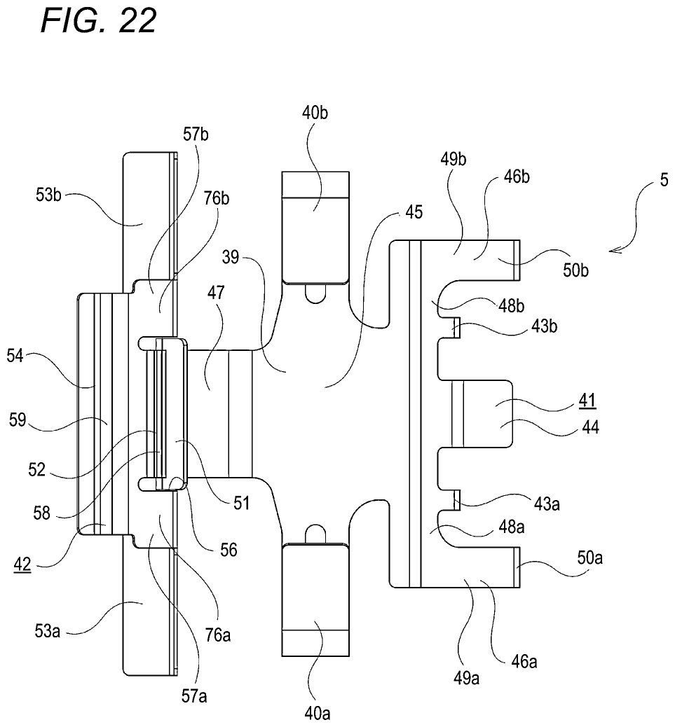

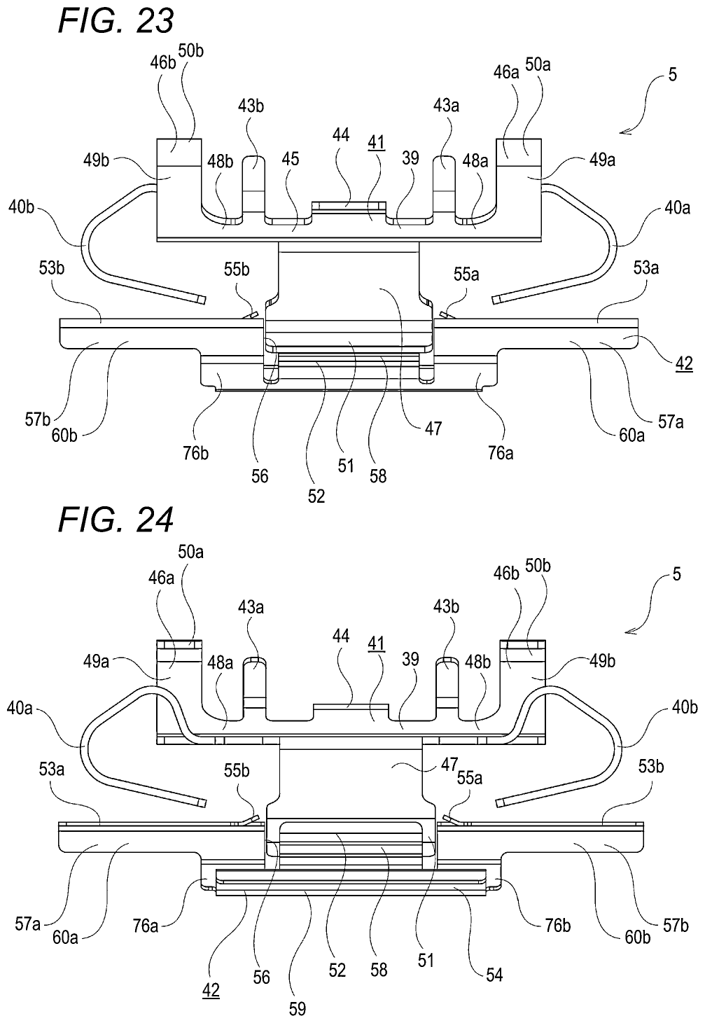

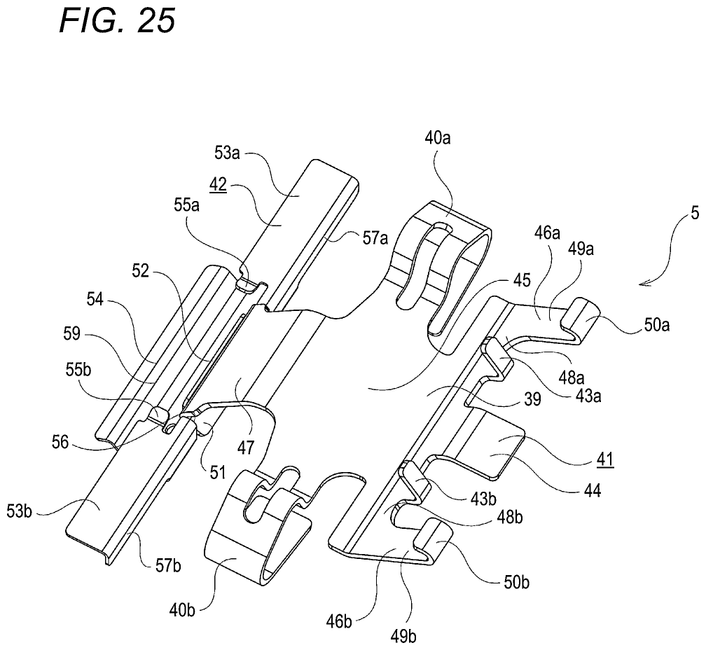

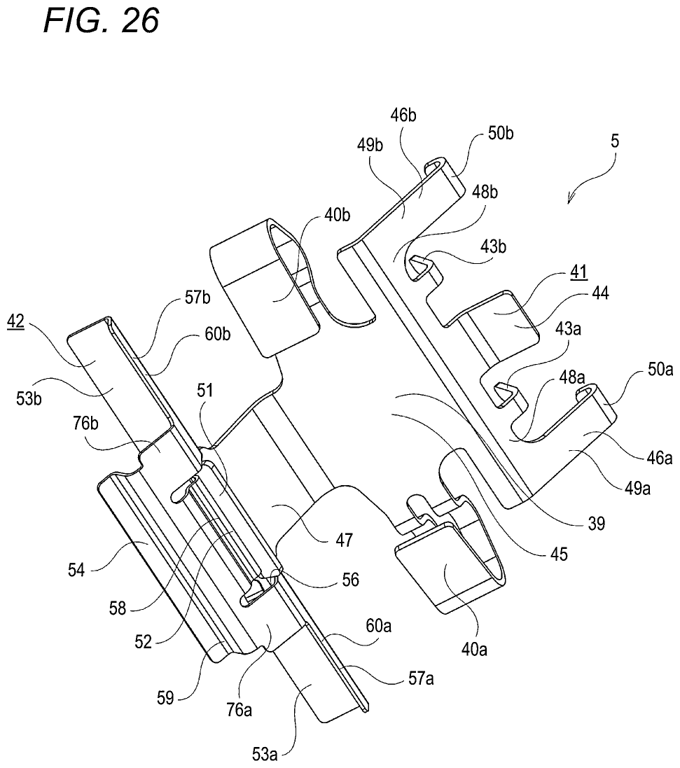

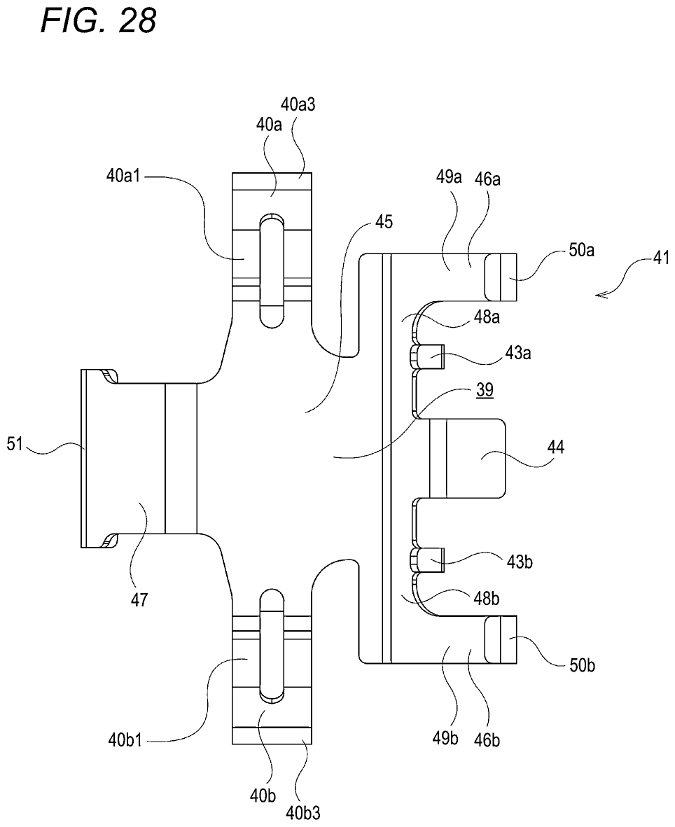

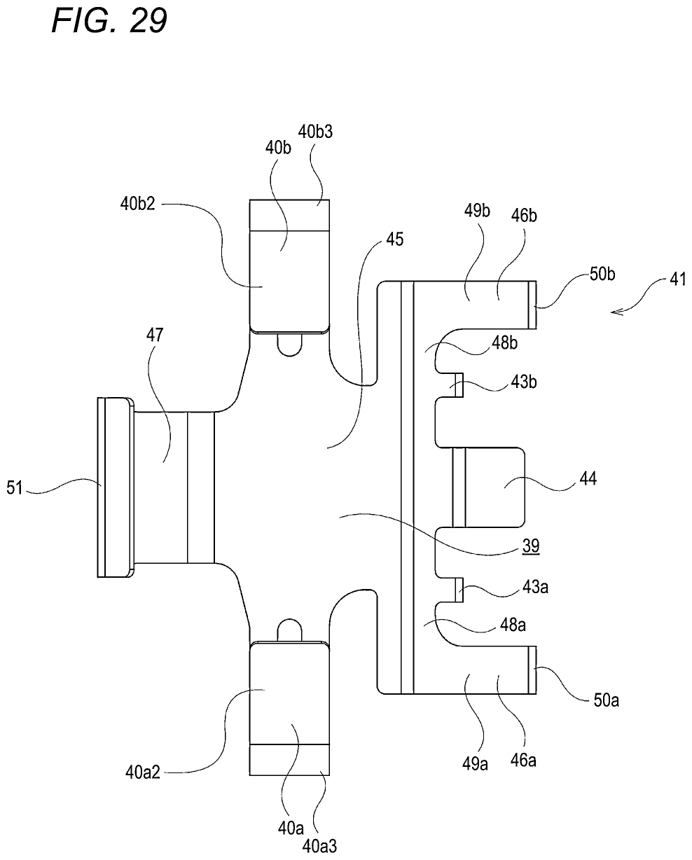

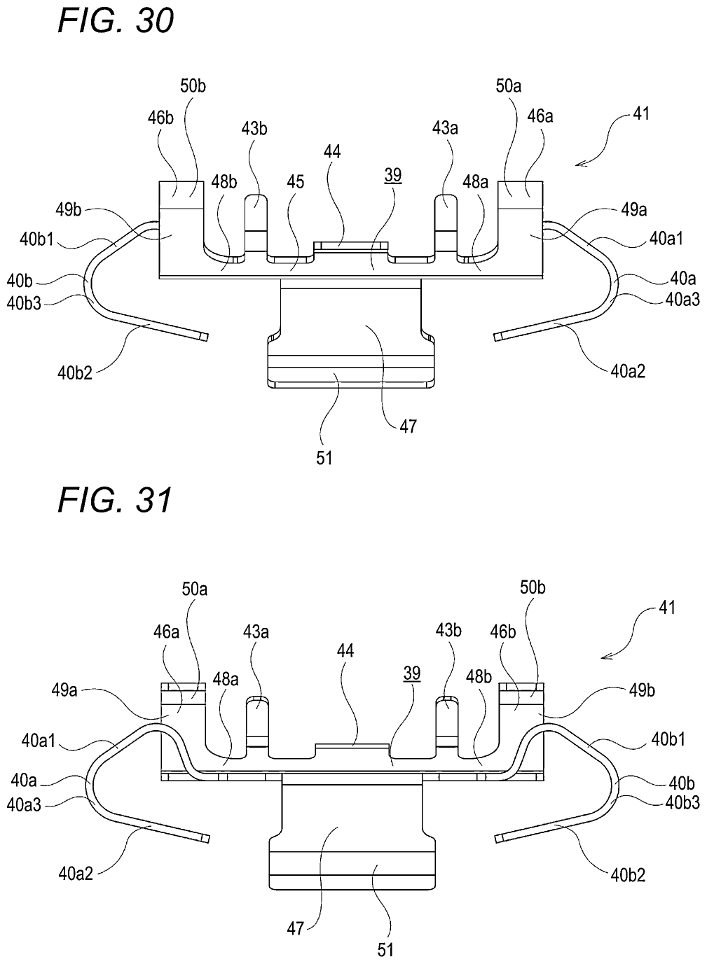

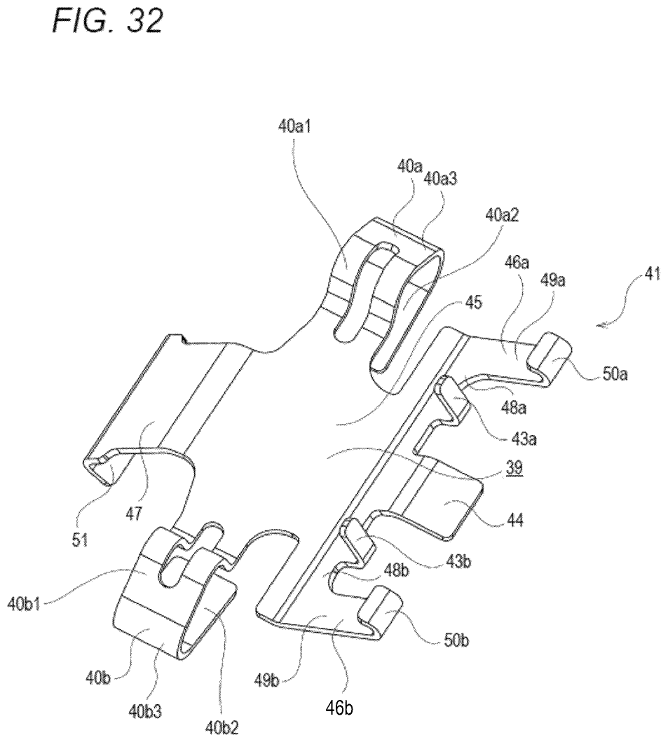

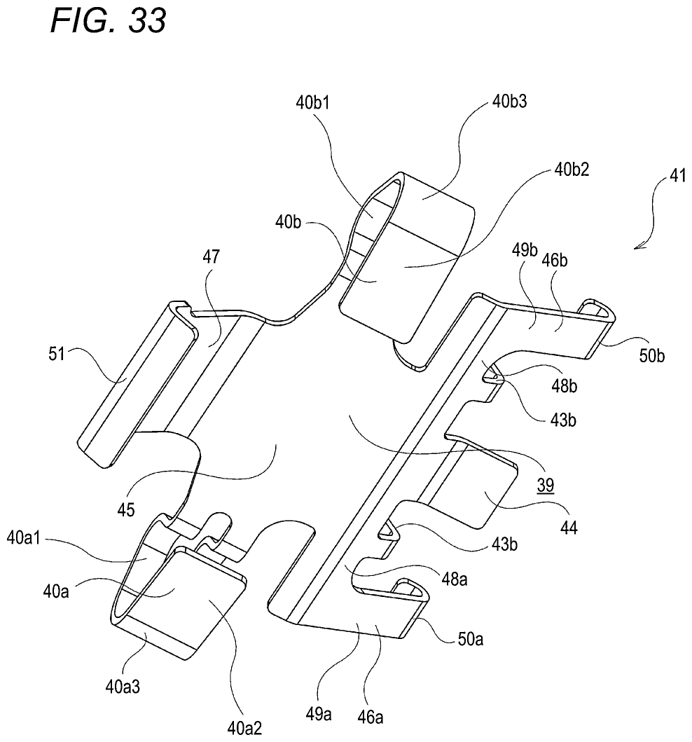

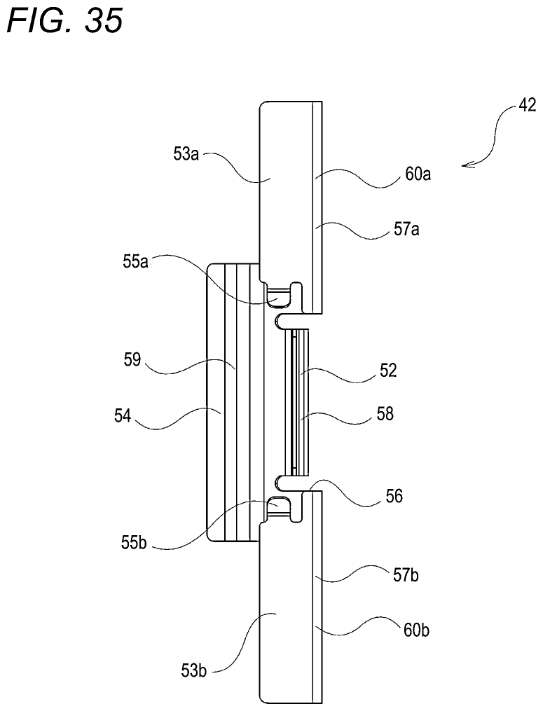

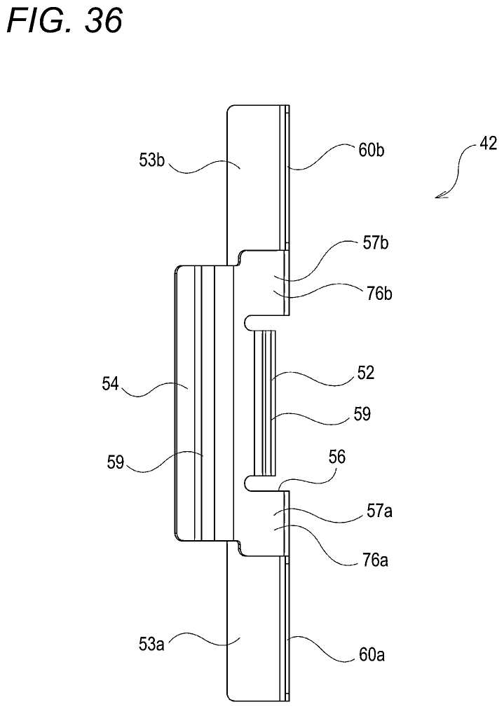

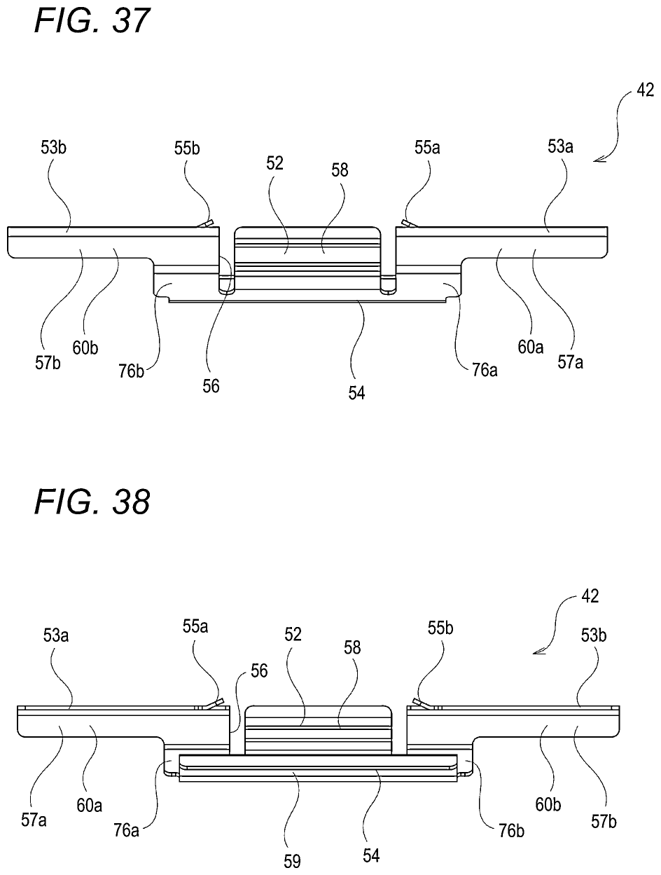

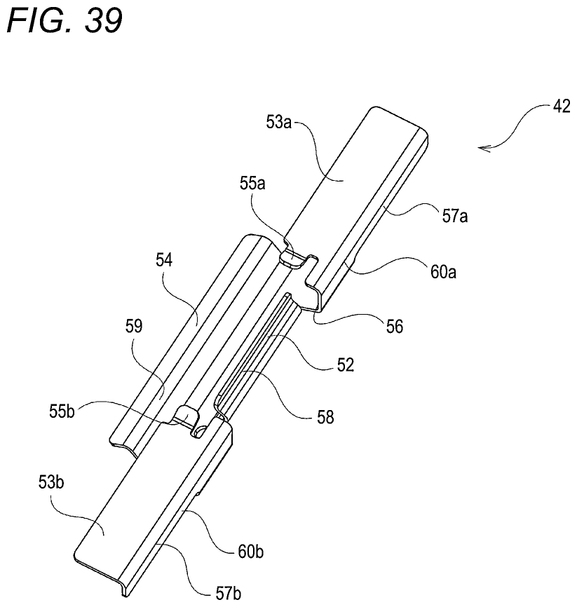

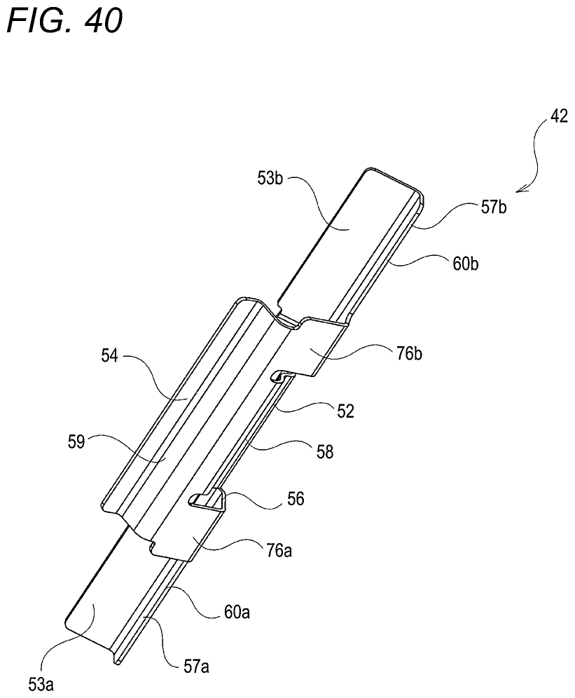

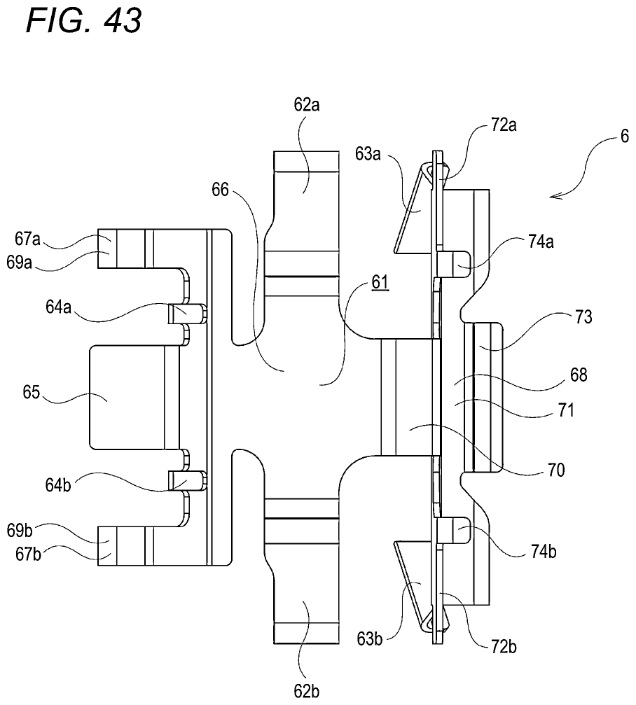

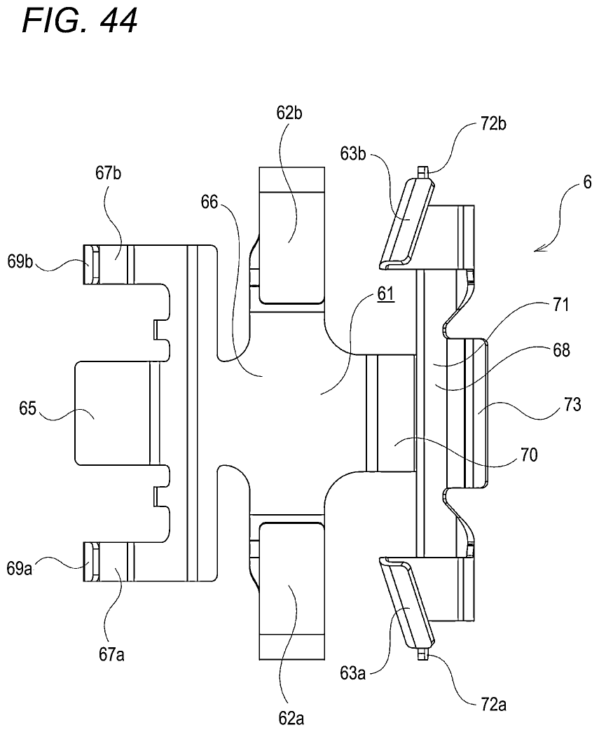

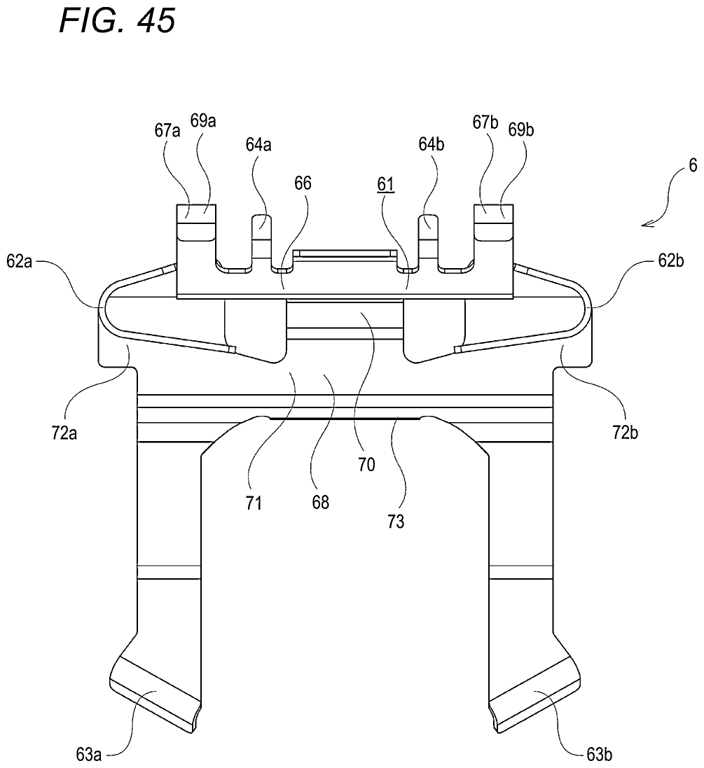

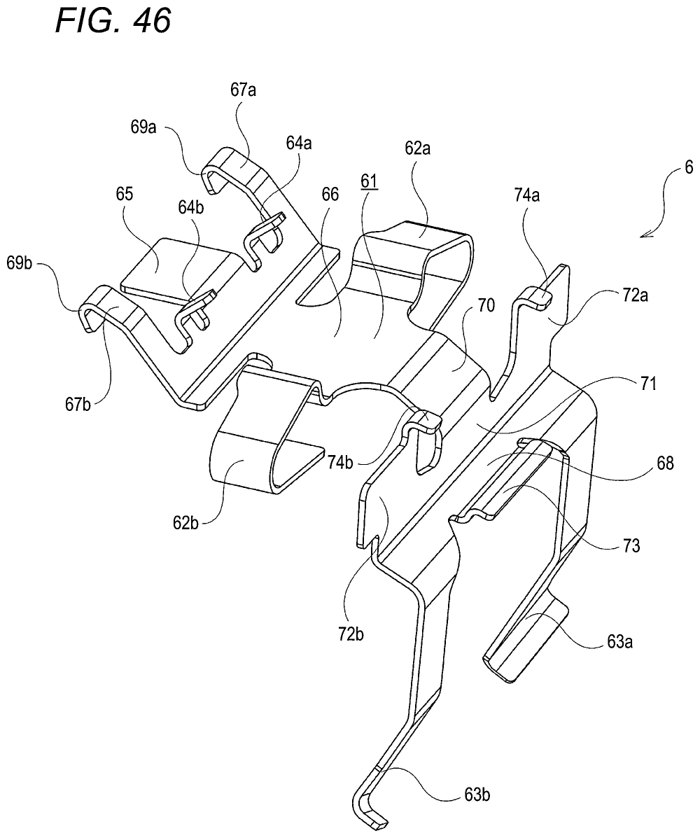

A first embodiment of the present disclosure will be described with reference to FIGS. 1 to 46.

The present embodiment is an embodiment in which a pad clip for a disc brake device according to the present disclosure is applied to an opposed piston type disc brake device used for braking an automobile.

Before describing a structure of a rotation-out side pad clip 5 of the present embodiment in detail, an overall structure of a disc brake device 1 will be described.

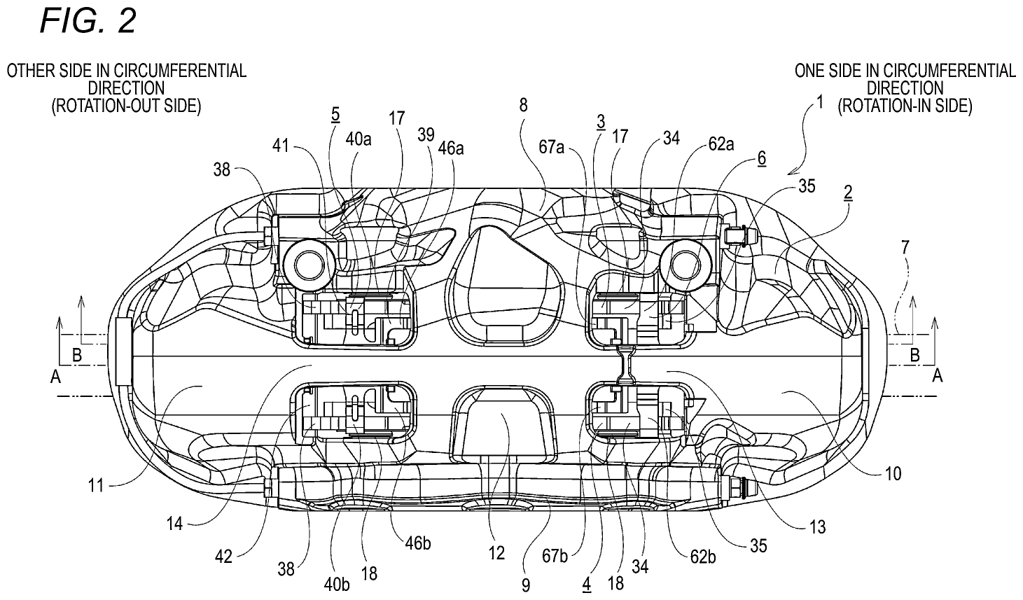

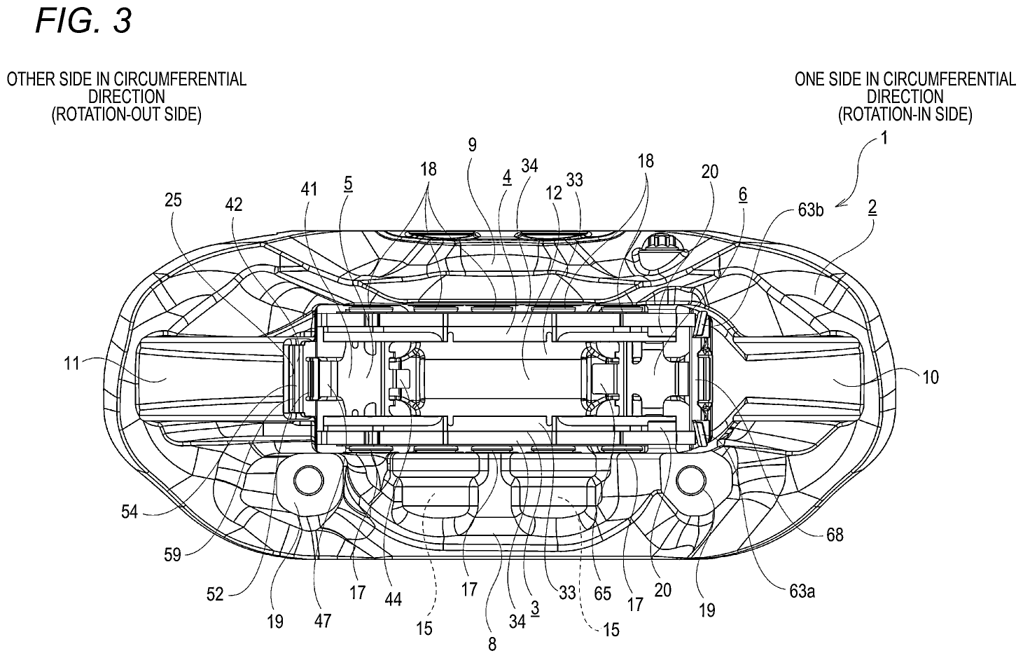

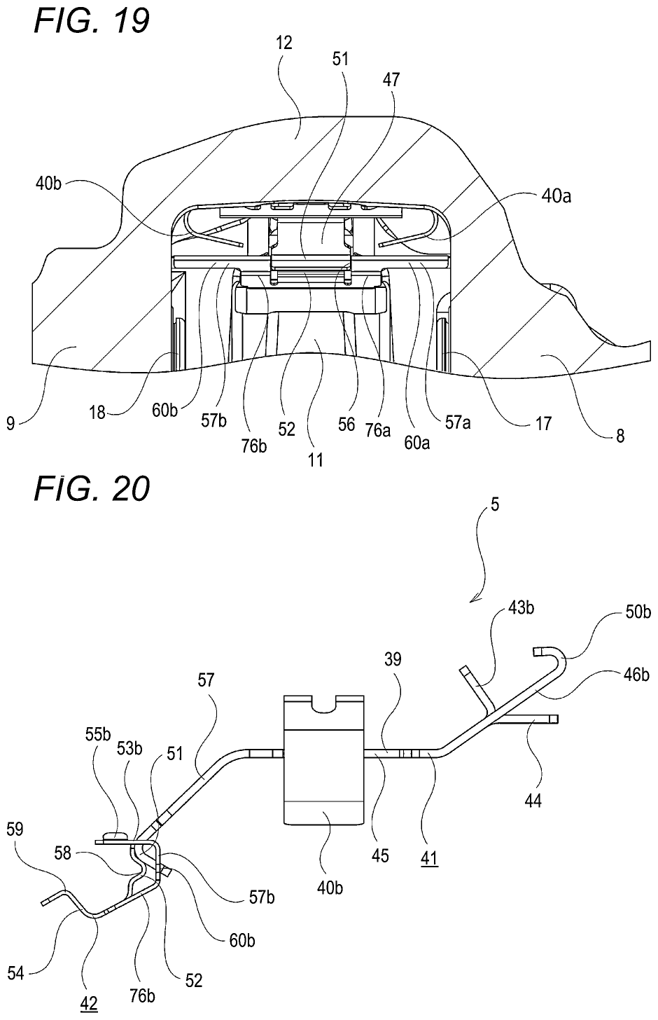

In the following description, unless otherwise specified, an axial direction, a circumferential direction, and a radial direction refer to an axial direction, a circumferential direction, and a radial direction of a disc-shaped rotor 7 (see FIG. 2) that rotates together with a wheel. A front-back direction in each of FIGS. 1, 6, 7, 10, 11, 14, 15, 17, and 18, an up-down direction in each of FIGS. 2, 3, 8, 9, 12, 13, and 16, and a left-right direction in FIG. 19 correspond to the axial direction, a side closer to the rotor 7 in relation to the axial direction is referred to as an axially inner side, and a side farther from the rotor 7 in relation to the axial direction is referred to as an axially outer side. Further, a left-right direction in each of FIGS. 1 to 3 and FIGS. 6 to 18 and a front-back direction in FIG. 19 correspond to the circumferential direction, a right side in each of FIGS. 1 to 3 and FIGS. 6 to 18 and a front side in FIG. 19 are referred to as one side in a circumferential direction, and a left side in each of FIGS. 1 to 3 and FIGS. 6 to 18 and a back side in FIG. 19 are referred to as the other side in a circumferential direction. In the present embodiment, the one side in the circumferential direction is a rotation-in side when the vehicle is moving forward, and the other side in the circumferential direction is a rotation-out side when the vehicle is moving forward. Further, an up-down direction in each of FIGS. 1, 6, 7, 10, 11, 14, 15, and 17 to 19, and a front-back direction in each of FIGS. 2, 3, 8, 9, 12, 13, and 16 correspond to the radial direction, an upper side in each of FIGS. 1, 6, 7, 10, 11, 14, 15, and 17 to 19, a front side in each of FIGS. 2, 8, 9, and 12, and a back side in each of FIGS. 3. 13, and 16 is the radially outer side, and each of a lower side in FIGS. 1, 6, 7, 10, 11, 14, 15, and 17 to 19, a back side in each of FIGS. 2, 8, 9, and 12, and a front side in each of FIGS. 3, 13, and 16 is the radially inner side. The rotation-in side refers to a side where the rotor 7 enters a caliper 2, and the rotation-out side refers to a side to which the rotor 7 exits from the caliper 2. An axial view refers to a view from the axial direction of the rotor 7, and a radial view refers to a view from the radial direction of the rotor 7.

### Description of Structure of Disc Brake Device

The disc brake device 1 of the present embodiment is an opposed piston type disc brake device used for braking an automobile, and includes the caliper 2, a pair of pads 3, 4 (inner pad 3 and outer pad 4), the rotation-out side pad clip 5, and a rotation-in side pad clip 6. In the present disclosure, the rotation-out side pad clip 5 corresponds to a pad clip for a disc brake device recited in the claims.

### <Caliper>

The caliper 2 supports each of the inner pad 3 and the outer pad 4 in a manner of being movable in the axial direction, and is integrally formed by subjecting a material made of a light alloy such as an aluminum alloy or an iron-based alloy to a casting process or the like.

The caliper 2 includes an inner body 8 and an outer body 9 that are disposed with the rotor 7 sandwiched, a rotation-in side end bridge 10 and a rotation-out side end bridge 11 that connect, in the axial direction, both end portions of each of the inner body 8 and the outer body 9 in the circumferential direction, a central bridge 12 that connects, in the axial direction, a circumferential intermediate portion of each of the inner body 8 and the outer body 9, a rotation-in side circumferential bridge 13, and a rotation-out side circumferential bridge 14. In the present disclosure, the rotation-out side end bridge 11 corresponds to an end bridge recited in the claims, and the rotation-out side circumferential bridge 14 corresponds to a circumferential bridge recited in the claims.

### <<Inner Body and Outer Body>>

The inner body 8 is disposed a center side of a vehicle body with respect to the rotor 7 in relation to the axial direction. The outer body 9 is disposed outside the vehicle body with respect to the rotor 7 in relation to the axial direction.

The inner body 8 includes a plurality of (five in the illustrated example) inner cylinders 15. An inner piston 17 is fitted to each of the inner cylinders 15 in a manner of being displaceable in the axial direction. The outer body 9 has the same number of outer cylinders 16 as the inner cylinders 15. An outer piston 18 is fitted to each of the outer cylinders 16 in a manner of being displaceable in the axial direction.

While covering the rotor 7 from the radially outer side, the caliper 2 is supported and fixed to a knuckle of a suspension device by an attachment seat 19 provided at the inner body 8.

Each of the inner body 8 and the outer body 9 includes a pin 20 on a radially inner side portion of a portion on the one side in the circumferential direction. The pair of pins 20 are coaxially supported and fixed (fixedly provided) to each other.

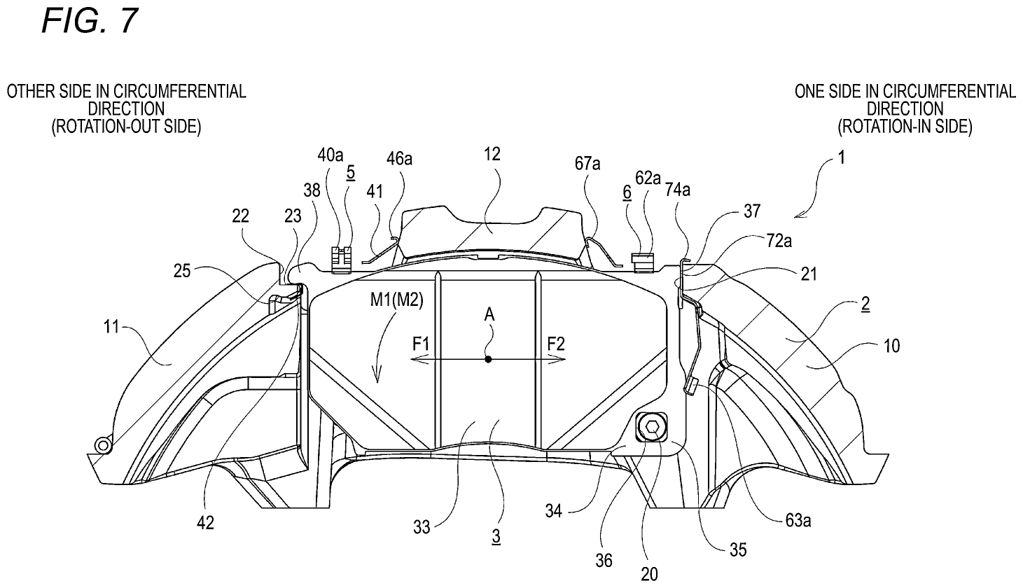

Distal end portions of the pins 20 protrude from axially inner side surfaces of the inner body 8 and the outer body 9 that face each other, and face both side surfaces of the rotor 7 in the axial direction with a gap therebetween. Each of portions of the pins 20 protruding from the axially inner side surfaces of the inner body 8 and the outer body 9 is a substantially columnar shape, and has a cylindrical outer circumferential surface. During forward braking, each of the pins 20 engages with a through hole 36 (described later) provided in each of the inner pad 3 and the outer pad 4 to support a brake tangential force F1 (see FIG. 7) acting on the inner pad 3 and the outer pad 4.

### <<End Bridge>>

The rotation-in side end bridge 10 is disposed on a radially outer side of an outer circumferential edge of the rotor 7. The rotation-in side end bridge 10 connects, in the axial direction, the portion of the inner body 8 on the one side in the circumferential direction and the portion of the outer body 9 on the one side in the circumferential direction.

The rotation-out side end bridge 11 is disposed on the radially outer side of the outer circumferential edge of the rotor 7. The rotation-out side end bridge 11 connects, in the axial direction, a portion of the inner body 8 on the other side in the circumferential direction and a portion of the outer body 9 on the other side in the circumferential direction.

The rotation-in side end bridge 10 and the rotation-out side end bridge 11 each have a partially cylindrical shape curved in an arc shape, and cover the rotor 7 from the radially outer side.

As illustrated in FIG. 7, in the rotation-in side end bridge 10, a pair of torque receiving surfaces 21 each having a flat surface shape are provided at portions, located on both sides with a connection portion with the rotation-in side circumferential bridge 13 sandwiched in relation to the axial direction, of a side surface on the other side in the circumferential direction facing the central bridge 12 in relation to the circumferential direction. The torque receiving surfaces 21 are present on a virtual plane orthogonal to directions of action lines of brake tangential forces F1, F2 (see FIG. 7). During reverse braking, each of the torque receiving surfaces 21 supports the brake tangential force F2 acting on each of the inner pad 3 and the outer pad 4 by abutting against a torque transmission surface 37 (described later) provided on each of the inner pad 3 and the outer pad 4.

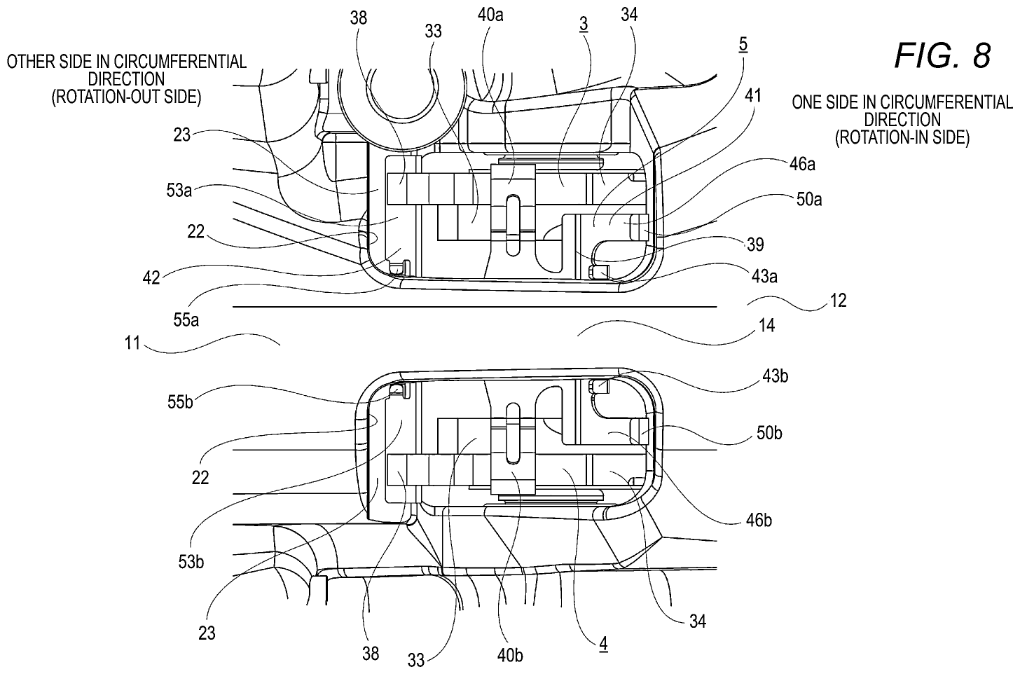

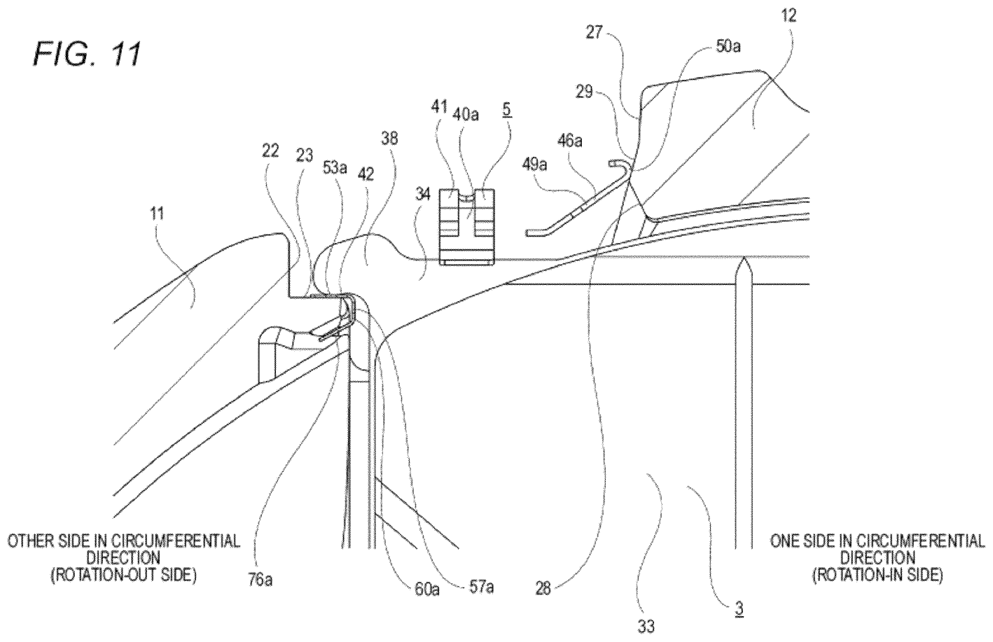

As illustrated in FIGS. 8 and 11, in the rotation-out side end bridge 11, accommodation recessed portions 22 having a substantially rectangular cross-sectional shape are provided in portions, located on both sides with an end portion of the rotation-out side circumferential bridge 14 on the other side in the circumferential direction sandwiched in relation to the axial direction, of a radially outer side portion of an end portion on the one side in the circumferential direction. The accommodation recessed portions 22 accommodate ear portions 38 (described later) respectively provided in the inner pad 3 and the outer pad 4.

In the rotation-out side end bridge 11, a pair of moment supporting surfaces 23 each having a flat surface shape are provided in portions, located on both sides with the end portion of the rotation-out side circumferential bridge 14 on the other side in the circumferential direction sandwiched in relation to the axial direction, of a radially outer side surface of an end portion on the one side in the circumferential direction. Each of the moment supporting surfaces 23 forms a bottom surface of the accommodation recessed portion 22 and is present on a virtual plane substantially orthogonal to the torque receiving surface 21. During the forward braking and the reverse braking, the ear portions 38 (described later) provided on the inner pad 3 and the outer pad 4 are pressed against the moment supporting surfaces 23. The moment supporting surfaces 23 support moment forces acting on the inner pad 3 and the outer pad 4.

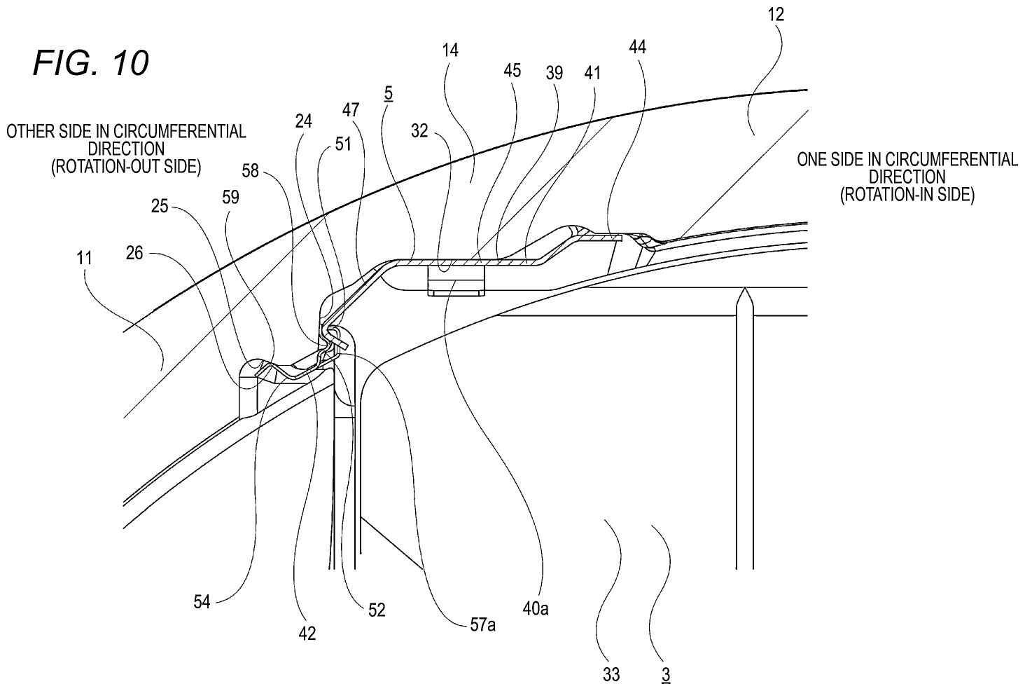

As illustrated in FIG. 10, in the rotation-out side end bridge 11, a rotation-out side pressed surface 24 is provided on a portion, located on a radially inner side of a connection portion with the rotation-out side circumferential bridge 14, of a side surface on the one side in the circumferential direction. The rotation-out side pressed surface 24 faces the one side in the circumferential direction and is present on a virtual plane substantially orthogonal to the moment supporting surface 23.

In the rotation-out side end bridge 11, a recessed portion 25 is provided in an axial intermediate portion of a radially inner side surface of an end portion on the one side in the circumferential direction. An end portion of a bottom surface of the recessed portion 25 on the one side in the circumferential direction is connected to an end portion of the rotation-out side pressed surface 24 on the radially inner side. An inner side clamping portion 54 (described later) forming the rotation-out side pad clip 5 is disposed in the recessed portion 25.

The bottom surface of the recessed portion 25 has an engagement inclination surface 26 that is inclined in a direction toward the radially inner side as approaching the one side in the circumferential direction. The engagement inclination surface 26 is engaged, in the circumferential direction, with a circumferential engagement portion 59 (described later) provided at the rotation-out side pad clip 5. An inclination angle of the engagement inclination surface 26 with respect to the moment supporting surface 23 is not particularly limited, but may be, for example, 15 degrees or more and 30 degrees or less. The inclination angle of the engagement inclination surface 26 with respect to the moment supporting surface 23 is 20 degrees in the illustrated example.

### <<Central Bridge>>

The central bridge 12 is disposed on the radially outer side of the outer circumferential edge of the rotor 7. The central bridge 12 is disposed on a portion between the rotation-in side end bridge 10 and the rotation-out side end bridge 11 in relation to the circumferential direction, and connects a circumferential central portion of the inner body 8 and a circumferential central portion of the outer body 9 in the axial direction. The central bridge 12 has a partially cylindrical shape curved in an arc shape, and covers the rotor 7 from the radially outer side.

As illustrated in FIG. 11, in the central bridge 12, center side pressed surfaces 27 are provided at portions, located on both sides with the connection portion with the rotation-out side circumferential bridge 14 sandwiched in relation to the axial direction, of the side surface on the other side in the circumferential direction.

In the center side pressed surfaces 27, a first inclination surface 28, which is inclined in a direction toward the other side in the circumferential direction as approaching the radially outer side, is provided at a radially inner side portion, and a second inclination surface 29, which is inclined in a direction toward the one side in the circumferential direction as approaching the radially outer side, is provided at a portion adjacent to the radially outer side of the first inclination surface 28.

### <<Circumferential Bridge>>

The rotation-in side circumferential bridge 13 and the rotation-out side circumferential bridge 14 are disposed on the radially outer side of the rotor 7.

The rotation-in side circumferential bridge 13 is hung between the rotation-in side end bridge 10 and the central bridge 12 in the circumferential direction, and connects the rotation-in side end bridge 10 and the central bridge 12 in the circumferential direction.

An end portion of the rotation-in side circumferential bridge 13 on the one side in the circumferential direction is connected to an axial intermediate portion of the side surface of the rotation-in side end bridge 10 on the other side in the circumferential direction, and the end portion of the rotation-in side circumferential bridge 13 on the other side in the circumferential direction is connected to an axial intermediate portion of the side surface of the central bridge 12 on the one side in the circumferential direction. The rotation-in side circumferential bridge 13 is disposed in the circumferential direction to cover the outer circumferential edge of the rotor 7 from the radially outer side.

The rotation-out side circumferential bridge 14 is hung between the rotation-out side end bridge 11 and the central bridge 12 in the circumferential direction, and connects the rotation-out side end bridge 11 and the central bridge 12 in the circumferential direction.

The end portion of the rotation-out side circumferential bridge 14 on the other side in the circumferential direction is connected to the axial intermediate portion of the side surface of the rotation-out side end bridge 11 on the one side in the circumferential direction, and an end portion of the rotation-out side circumferential bridge 14 on the one side in the circumferential direction is connected to an axial intermediate portion of the side surface of the central bridge 12 on the other side in the circumferential direction. The rotation-out side circumferential bridge 14 is disposed in the circumferential direction to cover the outer circumferential edge of the rotor 7.

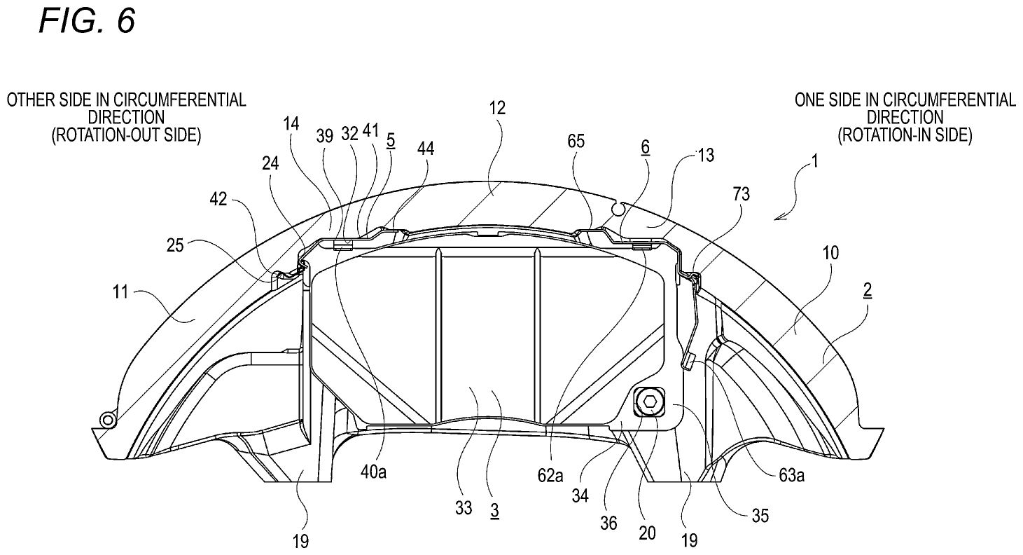

As illustrated in FIGS. 6 and 10, the rotation-out side circumferential bridge 14 has a pressed surface 32 having a flat surface shape at a circumferential intermediate portion of a radially inner side surface. The pressed surface 32 is disposed substantially parallel to the moment supporting surface 23.

### <Inner Pad and Outer Pad>

Each of the inner pad 3 and the outer pad 4 includes a lining (friction material) 33 and a metal back plate (pressure plate) 34 supporting a back surface of the lining 33.

The back plate 34 has a protruding portion 35 protruding in the circumferential direction from the lining 33 at the radially inner side portion of the end portion on the one side in the circumferential direction. In the protruding portion 35, the substantially rectangular through hole 36 penetrating in the axial direction is provided in a portion located on the radially inner side of an action line (friction surface center point A) of a brake tangential force acting during braking.

In a side surface of the back plate 34 on the one side in the circumferential direction, the torque transmission surface 37 having a flat surface shape and facing the torque receiving surface 21 in relation to the circumferential direction is provided on an end portion on the radially outer side of the action lines of the brake tangential forces F1, F2 acting during braking.

In the back plate 34, the convex ear portion 38 protruding toward the other side in the circumferential direction is provided on the end portion on the radially outer side of the end portion on the other side in the circumferential direction. The ear portion 38 supports the moment (rotational force) acting on each of the inner pad 3 and the outer pad 4 by abutting the moment supporting surface 23 against a radially inner side surface of the ear portion 38 during the forward braking and the reverse braking.

In order to support the inner pad 3 and the outer pad 4 in a manner of being movable in the axial direction with respect to the caliper 2, the pins 20 supported by the inner body 8 and the outer body 9 are loosely inserted in the axial direction into the through holes 36 provided in the back plates 34. The ear portions 38 provided on the back plates 34 are accommodated in the accommodation recessed portions 22 provided on the rotation-out side end bridge 11, and are engaged with the accommodation recessed portions 22 to be movable in the axial direction. In this state, the torque transmission surfaces 37 provided on the side surfaces of the back plates 34 on the one side in the circumferential direction face the torque receiving surfaces 21 provided on the rotation-in side end bridge 10 in the circumferential direction.

### <Pad Clip>

The disc brake device 1 of the present embodiment includes the rotation-out side pad clip 5 and the rotation-in side pad clip 6. The rotation-out side pad clip 5 and the rotation-in side pad clip 6 are attached to the caliper 2.

The rotation-out side pad clip 5 disposed on the other side in the circumferential direction presses, toward the radially inner side, the portions on the other side in the circumferential direction of the outer circumferential edge portions of the back plates 34 of the inner pad 3 and the outer pad 4 by a pair of pad pressing portions 40a, 40b.

The rotation-in side pad clip 6 disposed on the one side in the circumferential direction presses, toward the radially inner side, the portions on the one side in the circumferential direction of the outer circumferential edge portions of the back plates 34 of the inner pad 3 and the outer pad 4 by a pair of rotation-in side pad pressing portions 62a, 62b.

### <Regarding Moment Acting During Braking>

The disc brake device 1 of the present embodiment generates a moment in the same direction with respect to each of the inner pad 3 and the outer pad 4 during braking.

During forward braking, as illustrated in FIG. 7, a brake tangential force F1 directed to the other side in the circumferential direction (left side in FIG. 7, rotation-out side) acts on the friction surface center point A of the lining 33. Then, the through hole 36 and the pin 20 engage with each other to support the brake tangential force F1 (so-called pull anchor structure). Therefore, during the forward braking, a moment M1 in a direction in which a portion on the other side in the circumferential direction is pressed down toward the radially inner side acts on the inner pad 3 and the outer pad 4. The friction surface center point A is a centroid of a friction surface, which is determined by a diameter, an arrangement, and the like of a piston.

On the other hand, during the reverse braking, the brake tangential force F2 directed to the one side in the circumferential direction (right side in FIG. 7, rotation-in side) acts on the friction surface center A of the lining 33. Then, the torque transmission surface 37 abuts against the torque receiving surface 21 via clamped plate portions 72a, 72b (described later) forming the rotation-in side pad clip 6 to support the brake tangential force F2 (so-called push anchor structure). Therefore, during the reverse braking, a moment M2 in a direction in which the portion on the other side in the circumferential direction portion is pressed down toward the radially inner side (in the same direction as the moment M1) acts on the inner pad 3 and the outer pad 4.

According to the disc brake device 1 of the present embodiment, the directions of the moments M1 and M2 acting on the inner pad 3 and the outer pad 4 can be the same during the forward braking and the reverse braking. Therefore, even when the forward braking and the reverse braking are repeated as in the case of garage parking or the like, postures of the inner pad 3 and the outer pad 4 can be maintained in a state of counterclockwise rotation. Therefore, since it is unnecessary to change the postures of the inner pad 3 and the outer pad 4, it is possible to prevent clonk noise.

### Detailed Structure of Rotation-Out Side Pad Clip

Hereinafter, a structure of the rotation-out side pad clip 5 of the present embodiment will be described.

The rotation-out side pad clip 5 is mounted between the rotation-out side end bridge 11 and the central bridge 12. The rotation-out side pad clip 5 includes a main body portion 39 that is elastically supported between the rotation-out side end bridge 11 and the central bridge 12, and the pair of pad pressing portions 40a, 40b that press the outer circumferential edge portions of the inner pad 3 and the outer pad 4 toward the radially inner side.

The rotation-out side pad clip 5 of the present embodiment has a function of elastically pressing the inner pad 3 and the outer pad 4 to the radially inner side, and a function of covering the moment supporting surface 23 and preventing rust between the inner pad 3 and the caliper 2 and between the outer pad 4 and the caliper 2.

The rotation-out side pad clip 5 of the present embodiment includes a first clip 41 made of a metal plate and including the main body portion 39 and the pair of pad pressing portions 40a, 40b, and a second clip 42 made of a metal plate and assembled to the rotation-out side end bridge 11. That is, the rotation-out side pad clip 5 is configured by combining two clips, that is, the first clip 41 and the second clip 42.

However, the pad clip according to one aspect of the present disclosure may have only a function of elastically pressing the inner pad and the outer pad toward the radially inner side, and in this case, the pad clip can be formed by one clip (first clip) including the main body portion and the pair of pad pressing portions.

In the rotation-out side pad clip 5 of the present embodiment, the first clip 41 and the second clip 42 are engaged with each other in the axial direction and the radial direction and are abutted against each other in the circumferential direction.

In the present embodiment, the first clip 41 has a function of elastically pressing the inner pad 3 and the outer pad 4 to the radially inner side to push back the inner pad 3 and the outer pad 4 in the axial direction, and the second clip 42 has the function of covering the moment supporting surface 23 to prevent rust between the inner pad 3 and the caliper 2 and between the outer pad 4 and the caliper 2.

### <First Clip>

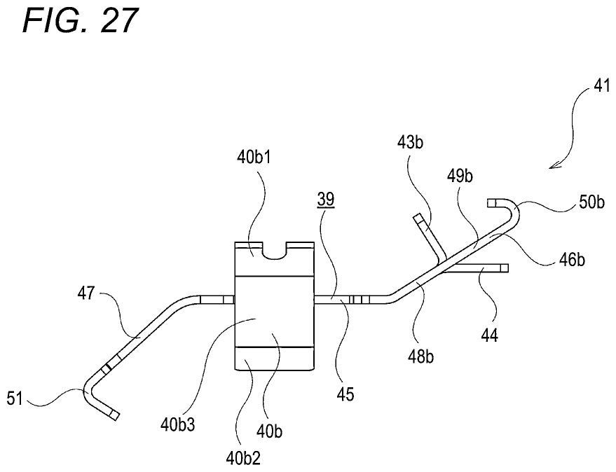

As illustrated in FIGS. 27 to 33, the first clip 41 is formed by bending one metal plate having elasticity and corrosion resistance, such as a stainless steel plate. The first clip 41 has a symmetrical shape in relation to the axial direction. The first clip 41 has a substantially cross shape in the radial view.

The first clip 41 is elastically mounted between the rotation-out side end bridge 11 and the central bridge 12.

The first clip 41 of the present embodiment includes a pair of first axial restriction portions 43a, 43b and a radial restriction portion 44 in addition to the main body portion 39 and the pair of pad pressing portions 40a, 40b.

### <<Main Body Portion>>

Most of the main body portion 39 is disposed on the radially inner side of the rotation-out side circumferential bridge 14, and is elastically supported between the rotation-out side end bridge 11 and the central bridge 12.

The main body portion 39 includes a substrate portion 45 provided in the circumferential intermediate portion, two first fixing portions 46a, 46b provided in an end portion on the one side in the circumferential direction, and one second fixing portion 47 provided in an end portion on the other side in the circumferential direction.

The main body portion 39 is elastically supported between the rotation-out side end bridge 11 and the central bridge 12 by pressing the first fixing portions 46a, 46b against the center side pressed surface 27 of the central bridge 12 in the circumferential direction and indirectly pressing the second fixing portion 47 against the rotation-out side pressed surface 24 of the rotation-out side end bridge 11 in the circumferential direction. In other words, a position of the main body portion 39 in the circumferential direction is restricted by the rotation-out side end bridge 11 and the central bridge 12.

The substrate portion 45 has a flat plate shape. A dimension of the substrate portion 45 in the axial direction is substantially the same as the dimension of the rotation-out side circumferential bridge 14 in the axial direction. A dimension of the substrate portion 45 in the circumferential direction is slightly larger than a dimension of the pressed surface 32 provided at the rotation-out side circumferential bridge 14 in the circumferential direction.

The substrate portion 45 is disposed on the radially inner side of the circumferential intermediate portion of the rotation-out side circumferential bridge 14 in a state where the first clip 41 is assembled to the caliper 2. As illustrated in FIG. 10, the substrate portion 45 is pressed against the pressed surface 32 in a state where the inner pad 3 and the outer pad 4 are assembled to the caliper 2.

The first fixing portions 46a, 46b each have a substantially L-shape in the radial view, and are connected to the end portions on both axially outer sides of the end portion of the substrate portion 45 on the one side in the circumferential direction. The first fixing portions 46a, 46b are disposed apart from each other in the axial direction.

The first fixing portions 46a, 46b include axial plate portions 48a, 48b extending toward the axially outer side from the end portion of the substrate portion 45 on the one side in the circumferential direction, and circumferential plate portions 49a, 49b extending toward the radially outer side from distal end portions of the axial plate portions 48a, 48b as approaching the one side in the circumferential direction. Inclination angles of the circumferential plate portions 49a, 49b with respect to the substrate portion 45 are not particularly limited, but are about 40 degrees in the illustrated example.

As illustrated in FIG. 8, the first fixing portions 46a, 46b are disposed on both sides of the rotation-out side circumferential bridge 14 in the axial direction in the state where the first clip 41 is assembled to the caliper 2.

The first fixing portions 46a, 46b have first fold-back portions 50a, 50b at distal end portions of the circumferential plate portions 49a, 49b. The first fold-back portions 50a, 50b are formed by folding back the distal end portions of the circumferential plate portions 49a, 49b toward the radially outer side and toward the other side in the circumferential direction by about 140 degrees. Side surfaces of the first fold-back portions 50a, 50b on the one side in the circumferential direction are formed by convex curved surfaces.

In the state where the first clip 41 is assembled to the caliper 2, the first fold-back portions 50a, 50b press, in the circumferential direction, the second inclination surface 29 of the center side pressed surfaces 27 provided in the central bridge 12.

The second fixing portion 47 has a substantially lateral J-shape in the axial view, and is connected to an axial intermediate portion of the end portion of the substrate portion 45 on the other side in the circumferential direction.

The second fixing portion 47 extends in a direction toward the radially inner side from the axial intermediate portion of the end portion of the substrate portion 45 on the other side in the circumferential direction as approaching the other side in the circumferential direction. An inclination angle of the second fixing portion 47 with respect to the substrate portion 45 is not particularly limited, but is about 40 degrees in the illustrated example. The second fixing portion 47 and the circumferential plate portions 49a, 49b of the first fixing portions 46a, 46b are disposed substantially parallel to each other.

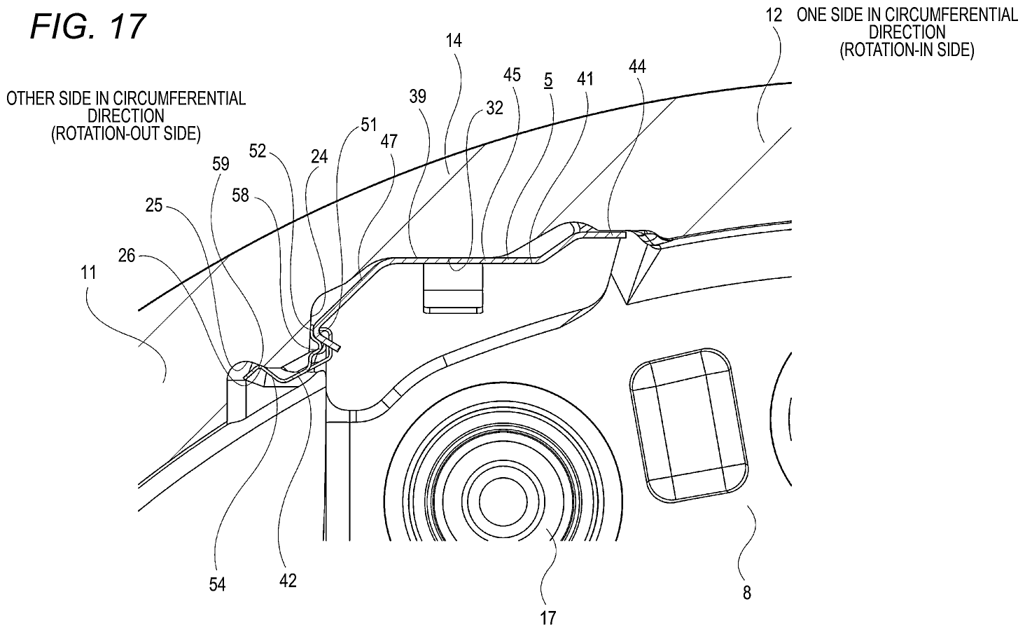

As illustrated in FIG. 17, the second fixing portion 47 is disposed on the radially inner side of the portion on the other side in the circumferential direction of the rotation-out side circumferential bridge 14 in the state where the first clip 41 is assembled to the caliper 2.

A distal end portion of the second fixing portion 47 is provided with a second fold-back portion 51. The second fold-back portion 51 is formed by folding back the distal end portion of the second fixing portion 47 toward the radially inner side and toward the one side in the circumferential direction by about 100 degrees. The second fold-back portion 51 has a shape bent to be convex on the other side in the circumferential direction, and a side surface on the other side in the circumferential direction is formed by a convex curved surface.

As illustrated in FIGS. 10 and 17, in the state where the first clip 41 is assembled to the caliper 2, the second fold-back portion 51 indirectly presses, in the circumferential direction, the rotation-out side pressed surface 24 provided at the rotation-out side end bridge 11 via an interposed portion 52 (described later) provided at the second clip 42.

### <<Pad Pressing Portion>>

The pad pressing portions 40a, 40b press the inner pad 3 and the outer pad 4, thereby stabilizing the postures of the inner pad 3 and the outer pad 4 in a non-braking state.

The pair of pad pressing portions 40a, 40b are disposed on both sides of the main body portion 39 in the axial direction, and are connected to the end portions on both sides of the substrate portion 45 in the axial direction.

The pad pressing portions 40a, 40b each have a lateral U-shape as viewed in the circumferential direction, and each have a band plate shape. The pad pressing portions 40a, 40b extend toward the axially outer side from the substrate portion 45, and are folded back toward the axially inner side by about 180 degrees from respective intermediate portions.

As illustrated in FIGS. 27 to 33, the pad pressing portions 40a, 40b have a configuration in which radially outer side portions 40a1, 40b1 extending in a direction toward the axially outer side (away from a rotor 7 in relation to the axial direction) from the substrate portion 45 and radially inner side portions 40a2, 40b2 disposed on radially inner sides of the radially outer side portions 40a1, 40b1 are connected to bent portions 40a3, 40b3.

The radially outer side portions 40a1, 40b1 of the pad pressing portions 40a, 40b each have a bending portion that is bent to protrude on the radially outer side at an axial intermediate portion. The bending portion and the substrate portion 45 are connected by a first linear portion extending linearly toward the axially outer side and toward the radially outer side, and the bending portion and the bent portions 40a3, 40b3 are connected by a second linear portion extending linearly toward the axially outer side and toward the radially inner side. Through holes, which are elongated holes in the axial direction, are formed in ranges across the first linear portion, the bending portion, and the second linear portion forming the radially outer side portions 40a1, 40b1. The radially inner side portions 40a2, 40b2 of the pad pressing portions 40a, 40b extend linearly toward the axially inner side and toward the radially inner side.

As illustrated in FIG. 8, the pad pressing portions 40a, 40b are disposed on both sides of the rotation-out side circumferential bridge 14 in relation to the axial direction in the state where the first clip 41 is assembled to the caliper 2.

When the inner pad 3 and the outer pad 4 are assembled, the pad pressing portions 40a, 40b are pressed toward the radially outer side by the outer circumferential edges of the back plates 34 and are elastically deformed (resiliently deformed) in the radial direction. Accordingly, portions on the other side in the circumferential direction of the outer circumferential edge portions of the back plates 34 are pressed toward the radially inner side and toward the axially outer side.

In the present embodiment, when the inner pad 3 and the outer pad 4 are assembled, the radially outer side surface of the substrate portion 45 forming the main body portion 39 is pressed against the pressed surface 32 provided in the rotation-out side circumferential bridge 14 by elastic forces (reaction forces) of the pad pressing portions 40a, 40b. Accordingly, the rotation-out side circumferential bridge 14 supports the reaction forces of the pad pressing portions 40a, 40b. A position of the main body portion 39 in the radial direction is regulated. The substrate portion 45 and the pressed surface 32 are in surface contact with each other.

### <<First Axial Restriction Portion>>

The first axial restriction portions 43a, 43b restrict a position of the first clip 41 in the axial direction and prevent an inclination of the first clip 41.

The first axial restriction portions 43a, 43b each have a substantially L-shape in the axial view, and are connected to both side portions in the axial direction of the end portion of the substrate portion 45 on the one side in the circumferential direction. Therefore, the first axial restriction portions 43a, 43a are disposed apart from each other in the axial direction, and are disposed between the pair of first fixing portions 46a, 46b in relation to the axial direction.

In the first axial restriction portions 43a, 43b, the radially inner side portions connected to the axial plate portions 48a, 48b extend in a direction toward the radially outer side as approaching the one side in the circumferential direction, and are disposed substantially parallel to the circumferential plate portions 49a, 49b of the first fixing portions 46a, 46b. A length dimension of each of the radially inner side portions of the first axial restriction portions 43a, 43b is about ½ of a length dimension of each of the circumferential plate portions 49a, 49b of the first fixing portions 46a, 46b.

Distal end portions (end portions on radially outer side) of the first axial restriction portions 43a, 43b are bent by about 90 degrees with respect to the portions of the first axial restriction portions 43a, 43b on the radially inner side, and extend toward the radially outer side and toward the other side in the circumferential direction. A length dimension of each of the distal end portions of the first axial restriction portions 43a, 43b is smaller than a dimension of the rotation-out side circumferential bridge 14 in the radial direction.

As illustrated in FIG. 8, in the state where the first clip 41 is assembled to the caliper 2, the first axial restriction portions 43a, 43b are disposed on both sides with the rotation-out side circumferential bridge 14 sandwiched in relation to the axial direction, and closely face both side surfaces of the rotation-out side circumferential bridge 14 in the axial direction.

The position of the first clip 41 in the axial direction is restricted by the first axial restriction portions 43a, 43b abutting against the side surfaces of the rotation-out side circumferential bridge 14 in the axial direction.

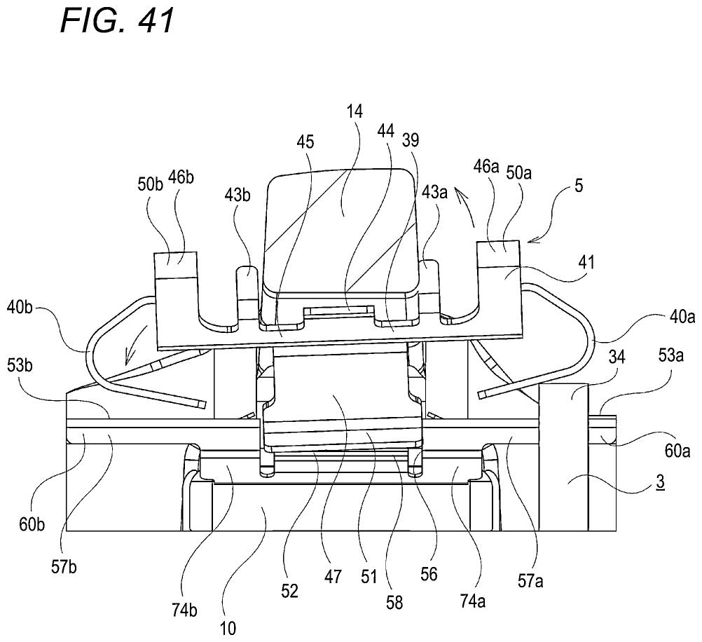

As illustrated in FIG. 41, when the inner pad 3 (or outer pad 4) is assembled, even if the one pad pressing portion 40a (40b) is pressed toward the radially outer side by the outer circumferential edge portion of the back plate 34, the one first axial restriction portion 43a (43b) abuts against the side surface of the rotation-out side circumferential bridge 14 in the axial direction. Accordingly, the first clip 41 is prevented from such an inclination that the portion on the one side in the axial direction is raised on the radially outer side and the portion on the other side in the axial direction is lowered on the radially inner side.

### <<Radial Restriction Portion>>

The radial restriction portion 44 prevents abutting positions of the first fixing portions 46a, 46b from being displaced toward the radially outer side from normal positions.

The radial restriction portion 44 has a flat plate shape, and is connected to an axial intermediate portion of the end portion of the substrate portion 45 on the one side in the circumferential direction. Therefore, the radial restriction portion 44 is disposed between the pair of first axial restriction portions 43a, 43b in relation to the axial direction. The radial restriction portion 44 is arranged substantially parallel to the substrate portion 45.

When the first clip 41 is assembled to the caliper 2, the radial restriction portion 44 abuts against the radially inner side surface of the rotation-out side circumferential bridge 14. Specifically, as will be described later, when pushing up the second fixing portion 47 toward the radially outer side, the radial restriction portion 44 abuts against the radially inner side surface of the rotation-out side circumferential bridge 14. Accordingly, abutting positions of the first fold-back portions 50a, 50b with respect to the center side pressed surfaces 27 of the central bridge 12 are prevented from being displaced toward the radially outer side from the normal positions (positions on the radially outer side which is slightly outside the connection portion of the second inclination surface 29 with the first inclination surface 28). After the first clip 41 is assembled to the caliper 2, the radial restriction portion 44 does not abut against the radially inner side surface of the rotation-out side circumferential bridge 14.

### <Second Clip>

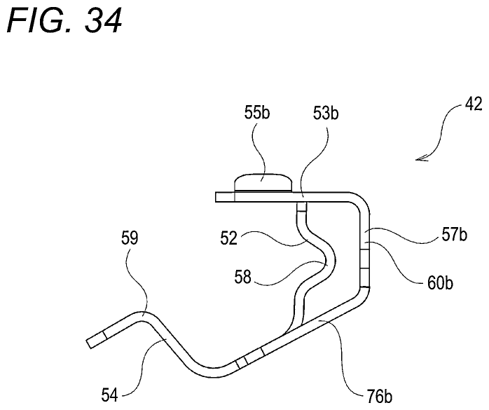

As illustrated in FIGS. 34 to 40, the second clip 42 is formed by bending one metal plate having elasticity and corrosion resistance, such as a stainless steel plate. The second clip 42 has a symmetrical shape in relation to the axial direction.

The second clip 42 is assembled to the end portion of the rotation-out side end bridge 11 on the one side in the circumferential direction. In the present embodiment, the second clip 42 is mounted to the rotation-out side end bridge 11 by elastically clamping, from both sides in the radial direction, the end portion of the rotation-out side end bridge 11 on the one side in the circumferential direction.

The second clip 42 includes the interposed portion 52. In the present embodiment, the second clip 42 includes, in addition to the interposed portion 52, two outer side clamping portions 53a, 53b, the one inner side clamping portion 54, a pair of second axial restriction portions 55a, 55b, an axial engagement portion 56, and connection plate portions 57a, 57b.

The interposed portion 52 is provided at an axial intermediate portion of the second clip 42. The interposed portion 52 rises in the radial direction and is provided at a circumferential intermediate portion of the second clip 42.

At a radial intermediate portion, the interposed portion 52 has a radial engagement portion 58 that is bent to be convex on the one side in the circumferential direction. The radial engagement portion 58 has a substantially lateral V shape in the axial view. The interposed portion 52 has an end portion on the radially outer side which is a free end, and an end portion on the radially inner side which is connected to the end portion of the inner side clamping portion 54 on the one side in the circumferential direction.

As illustrated in FIGS. 10 and 17, in a state where the second clip 42 is assembled to the caliper 2, the interposed portion 52 is disposed on the radially inner side of the portion of the rotation-out side circumferential bridge 14 on the other side in the circumferential direction and covers the rotation-out side pressed surface 24.

In a state where the rotation-out side pad clip 5 is assembled to the caliper 2, the interposed portion 52 is disposed (sandwiched) between the rotation-out side pressed surface 24 and the second fold-back portion 51 of the second fixing portion 47. Specifically, a distal end portion of the second fold-back portion 51 abuts against a flat plate portion, located on the radially outer side of the radial engagement portion 58, of the interposed portion 52, and the second fold-back portion 51 and the radial engagement portion 58 are engaged with each other in the radial direction (the second fold-back portion 51 presses the radial engagement portion 58 toward the radially inner side). Accordingly, the position (abutting position) of the second fold-back portion 51 in the radial direction is prevented from being displaced toward the radially inner side.

The second clip 42 is mounted to the rotation-out side end bridge 11 by elastically clamping the end portion of the rotation-out side end bridge 11 on the one side in the circumferential direction from both sides in the radial direction by the two outer side clamping portions 53a, 53b and the one inner side clamping portion 54. Therefore, the position of the second clip 42 in the radial direction is restricted by the outer side clamping portions 53a, 53b and the inner side clamping portion 54.

The outer side clamping portions 53a, 53b are provided on the radially outer side portion of the second clip 42. The outer side clamping portions 53a, 53b each have a flat plate shape, and are disposed apart from each other in the axial direction. The outer side clamping portions 53a, 53b each have a size sufficient to cover most of the moment supporting surface 23 provided in the rotation-out side end bridge 11.

As illustrated in FIG. 8, in the state where the second clip 42 is assembled to the caliper 2, the outer side clamping portions 53a, 53b are disposed on both sides with the end portion of the rotation-out side circumferential bridge 14 on the other side in the circumferential direction sandwiched in relation to the axial direction. The outer side clamping portions 53a, 53b cover the moment supporting surfaces 23 provided on the rotation-out side end bridge 11, and elastically press the moment supporting surfaces 23 toward the radially inner side. The outer side clamping portions 53a, 53b are in surface contact with the moment supporting surfaces 23.

In the state where the inner pad 3 and the outer pad 4 are assembled, each of the outer side clamping portions 53a, 53b is clamped between the moment supporting surface 23 and the radially inner side surface of the ear portion 38 provided at the back plate 34. Accordingly, during braking, the outer side clamping portions 53a, 53b receive moment forces acting on the inner pad 3 and the outer pad 4. The outer side clamping portions 53a, 53b reduce drag resistance of the inner pad 3 and the outer pad 4, and prevent rust from occurring between the moment supporting surface 23 and the radially inner side surface of the ear portion 38.

The inner side clamping portion 54 is provided at the end portion on the other side in the circumferential direction of the radially inner side portion of the second clip 42. The end portion of the inner side clamping portion 54 on the one side in the circumferential direction is connected to the end portion of the interposed portion 52 on the radially inner side. The inner side clamping portion 54 has a dimension in the axial direction slightly larger than that of the interposed portion 52.

The inner side clamping portion 54 has a corrugated plate shape. The inner side clamping portion 54 protrudes to the other side in the circumferential direction of the outer side clamping portions 53a, 53b. The inner side clamping portion 54 has the circumferential engagement portion 59 at a portion protruding to the other side in the circumferential direction of the outer side clamping portions 53a, 53b. The circumferential engagement portion 59 is bent to be convex on the radially outer side, and has a substantially inverted V shape in the axial view.

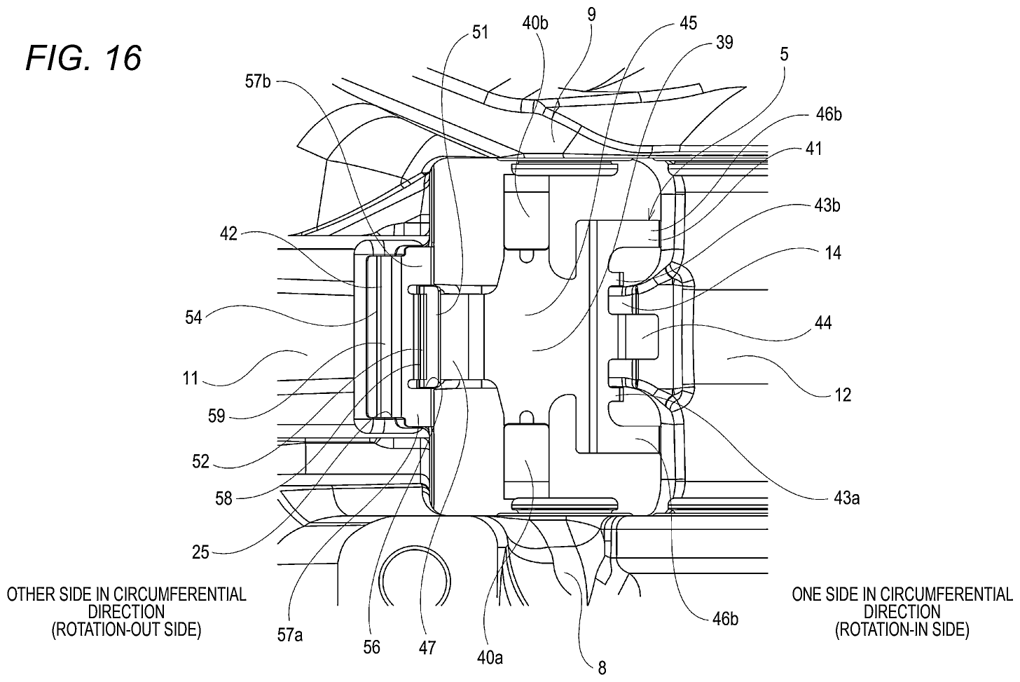

As illustrated in FIGS. 10 and 16, in the state where the second clip 42 is assembled to the caliper 2, the inner side clamping portion 54 is disposed on the radially inner side of the end portion of the rotation-out side end bridge 11 on the one side in the circumferential direction. In this case, the circumferential engagement portion 59 is disposed inside the recessed portion 25 provided in the rotation-out side end bridge 11, presses the engagement inclination surface 26 forming the bottom surface of the recessed portion 25 toward the radially outer side, and is engaged with the engagement inclination surface 26 in the circumferential direction. Since the circumferential engagement portion 59 and the engagement inclination surface 26 are engaged with each other in the circumferential direction, the second clip 42 is prevented from such an inclination that the second clip 42 comes out of the rotation-out side end bridge 11, and a gap is prevented from being formed between the outer side clamping portions 53a, 53b and the moment supporting surface 23.

End portions of the outer side clamping portions 53a, 53b on the one side in the circumferential direction and the end portion of the inner side clamping portion 54 on the one side in the circumferential direction are connected to the connection plate portions 57a, 57b. The connection plate portions 57a, 57b are provided at the end portion of the second clip 42 on the one side in the circumferential direction, and have a substantially L-shape in the axial view.

The connection plate portions 57a, 57b include standing plate portions 60a, 60b and lateral plate portions 76a, 76b. The standing plate portions 60a, 60b are bent at a substantially right angle toward the radially inner side from the end portions of the outer side clamping portions 53a, 53b on the one side in the circumferential direction. The lateral plate portions 76a, 76b are bent toward the other side in the circumferential direction from end portions of the standing plate portions 60a, 60b on the radially inner side, and are connected to the end portion of the inner side clamping portions 54 on the one side in the circumferential direction. In the illustrated example, the lateral plate portions 76a, 76b are bent about 80 degrees with respect to the standing plate portions 60a, 60b.

The standing plate portions 60a, 60b each have a flat plate shape, and are disposed apart from each other in the axial direction. The standing plate portions 60a, 60b are displaced to the one side in the circumferential direction from the interposed portion 52. The standing plate portions 60a, 60b have approximately the same dimension in the axial direction as that of the outer side clamping portions 53a, 53b.

In the state where the second clip 42 is assembled to the caliper 2, the standing plate portions 60a, 60b cover the side surface of the rotation-out side end bridge 11 on the one side in the circumferential direction.

The lateral plate portions 76a, 76b each have a flat plate shape, and are disposed apart from each other in the axial direction. The lateral plate portions 76a, 76b are smaller in the dimension in the axial direction than that of the standing plate portions 60a, 60b. The lateral plate portions 76a, 76b connect end portions of the standing plate portions 60a, 60b on the axially inner side to an end portion of the inner side clamping portion 54 on the axially outer side.

The axial engagement portion 56 has a width in the axial direction slightly larger than a width of the second fixing portion 47 of the first clip 41 in the axial direction, and is engaged with the second fixing portion 47 in the axial direction.

In the present embodiment, the axial engagement portion 56 is provided at a portion of the second clip 42 between the two connection plate portions 57a, 57b disposed apart from each other in the axial direction. In other words, end edges of the two connection plate portions 57a, 57b on the axially inner side form the axial engagement portion 56.

The axial engagement portion 56 is engaged, in the axial direction, with the end portion of the second fixing portion 47 on the other side in the circumferential direction. Accordingly, a position of the second fixing portion 47 in the axial direction is restricted.

The second axial restriction portions 55a, 55b closely face both side surfaces of the rotation-out side circumferential bridge 14 in the axial direction. Therefore, the position of the second clip 42 in the axial direction is restricted by the second axial restriction portions 55a, 55b abutting against the side surfaces of the rotation-out side circumferential bridge 14 in the axial direction.

The second axial restriction portions 55a, 55b are provided on end portions of the outer side clamping portions 53a, 53b on the axially inner side. The second axial restriction portions 55a, 55b are bent in a direction toward the radially outer side as approaching the axially inner side.

### <Method for Mounting Rotation-Out Side Pad Clip>

The rotation-out side pad clip 5 of the present embodiment is assembled in the following procedure before the inner pad 3 and the outer pad 4 are assembled to the caliper 2.

First, the second clip 42 forming the rotation-out side pad clip 5 is assembled to the caliper 2. Specifically, the rotation-out side end bridge 11 is elastically clamped from both sides in the radial direction by the two outer side clamping portions 53a, 53b and the one inner side clamping portion 54 forming the second clip 42 to assemble the second clip 42 to the end portion of the rotation-out side end bridge 11 on the one side in the circumferential direction.

In the state where the second clip 42 is assembled to the end portion of the rotation-out side end bridge 11 on the one side in the circumferential direction, the outer side clamping portions 53a, 53b cover the moment supporting surface 23 from the radially outer side, and the interposed portion 52 covers the rotation-out side pressed surface 24 from the one side in the circumferential direction. The circumferential engagement portion 59 provided at the inner side clamping portion 54 is disposed inside the recessed portion 25 provided in the radially inner side surface of the rotation-out side end bridge 11, presses the engagement inclination surface 26 toward the radially outer side, and is engaged with the engagement inclination surface 26 in the circumferential direction. The second axial restriction portions 55a, 55b provided in the outer side clamping portions 53a, 53b closely face both side surfaces of the rotation-out side circumferential bridge 14 in the axial direction.

Next, the first clip 41 forming the rotation-out side pad clip 5 is assembled to the caliper 2 on which the second clip 42 is mounted.

Specifically, the main body portion 39 of the first clip 41 is disposed at the radially inner side of the rotation-out side circumferential bridge 14, and the first fold-back portions 50a, 50b of the first fixing portions 46a, 46b abut against the center side pressed surfaces 27 provided at the central bridge 12. In this case, the radial restriction portion 44 forming the first clip 41 does not abut against the radially inner side surface of the rotation-out side circumferential bridge 14.

Thereafter, by pushing up the second fixing portion 47 toward the radially outer side, the second fold-back portion 51 is moved toward the radially outer side of the radial engagement portion 58 forming the interposed portion 52. Then, the second fold-back portion 51 is pressed against the rotation-out side pressed surface 24 in the circumferential direction via a radially outer side portion of the interposed portion 52. Accordingly, the main body portion 39 of the first clip 41 is assembled between the rotation-out side end bridge 11 and the central bridge 12.

When the second fold-back portion 51 climbs over the radial engagement portion 58 toward the radially outer side, a sound (snapping sound) is generated and a click feeling is generated, and thus a worker who installs the first clip 41 can confirm that the second fold-back portion 51 climbs over the radial engagement portion 58 to be attached.

In a case of pushing up the second fixing portion 47 toward the radially outer side, the radial restriction portion 44 abuts against the radially inner side surface of the rotation-out side circumferential bridge 14 to prevent the positions in the radial direction of the first fold-back portions 50a, 50b with respect to the center side pressed surface 27 of the central bridge 12 from being displaced toward the radially outer side from the normal positions.

In the state where the first clip 41 is assembled between the rotation-out side end bridge 11 and the central bridge 12, the second fixing portion 47 is engaged with the radial engagement portion 58 of the second clip 42 in the radial direction and is engaged with the axial engagement portion 56 of the second clip 42 in the axial direction. The first axial restriction portions 43a, 43b are disposed to closely face both side surfaces of the rotation-out side circumferential bridge 14 in the axial direction.

### (Detailed Structure of Rotation-In Side Pad Clip)

Hereinafter, the structure of the rotation-in side pad clip 6 of the present embodiment will be described.

The rotation-in side pad clip 6 has a function of pressing the inner pad 3 and the outer pad 4 toward the radially inner side, a function of pressing the inner pad 3 and the outer pad 4 toward the other side in the circumferential direction, and a function of preventing rust from occurring between the torque transmission surface 37 and the torque receiving surface 21.

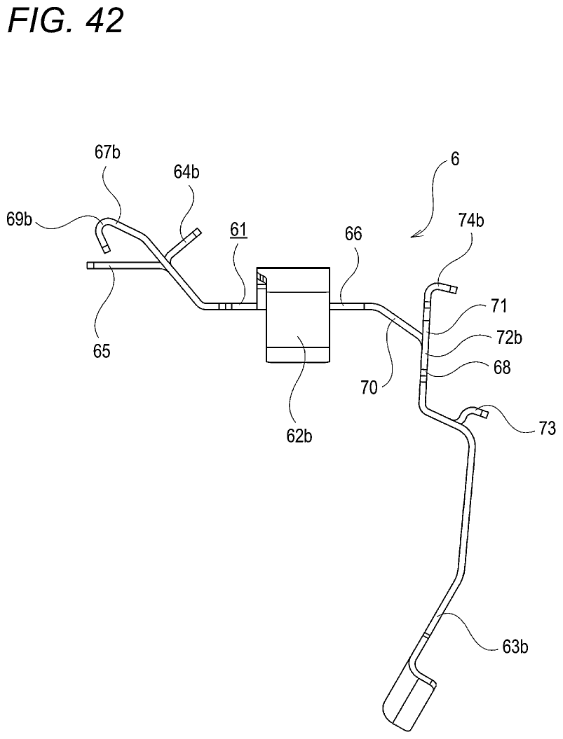

As illustrated in FIGS. 42 to 46, the rotation-in side pad clip 6 is formed by bending one metal plate having elasticity and corrosion resistance, such as a stainless steel plate. The rotation-in side pad clip 6 has a symmetrical shape in relation to the axial direction.

The rotation-in side pad clip 6 is elastically mounted between the rotation-in side end bridge 10 and the central bridge 12.

A half portion of the rotation-in side pad clip 6 on the radially outer side is disposed on a portion between the rotation-in side end bridge 10 and the central bridge 12 in a state where the rotation-in side pad clip 6 is assembled to the caliper 2. A half portion of the rotation-in side pad clip 6 on the radially inner side is disposed on the one side in the circumferential direction of the inner pad 3 and the outer pad 4.

The rotation-in side pad clip 6 includes a plurality of structures common to the first clip 41 forming the rotation-out side pad clip 5 at the half portion on the radially outer side.

The rotation-in side pad clip 6 includes a rotation-in side main body portion 61, the pair of rotation-in side pad pressing portions 62a, 62b, a pair of circumferential pressing portions 63a, 63b, a pair of rotation-in side first axial restriction portions 64a, 64b, a rotation-in side radial restriction portion 65, and rotation-in side second axial restriction portions 74a, 74b.

### <<Rotation-In Side Main Body Portion>>

The rotation-in side main body portion 61 is elastically supported between the rotation-in side end bridge 10 and the central bridge 12.

The rotation-in side main body portion 61 is provided at the half portion of the rotation-in side pad clip 6 on the radially outer side. The rotation-in side main body portion 61 includes a rotation-in side substrate portion 66 having a flat plate shape and provided at a circumferential intermediate portion, two rotation-in side first fixing portions 67a, 67b provided at the end portion on the other side in the circumferential direction, and a rotation-in side second fixing portion 68 provided at the end portion on the one side in the circumferential direction.

The rotation-in side first fixing portions 67a, 67b are elastically pressed in the circumferential direction against the side surface of the central bridge 12 on the one side in the circumferential direction, and the rotation-in side second fixing portion 68 is attached to the end portion of the rotation-in side end bridge 10 on the other side in the circumferential direction, so that the rotation-in side main body portion 61 is elastically supported between the rotation-in side end bridge 10 and the central bridge 12.

In the state where the rotation-in side pad clip 6 is assembled to the caliper 2, the rotation-in side substrate portion 66 is disposed on the radially inner side of the rotation-in side circumferential bridge 13, but even after the inner pad 3 and the outer pad 4 are assembled to the caliper 2, a radially inner side surface of the rotation-in side circumferential bridge 13 is not pressed.

The rotation-in side first fixing portions 67a, 67b each have a substantially L-shape in the radial view, and are connected to the end portions on both axially outer sides of the end portion of the rotation-in side substrate portion 66 on the other side in the circumferential direction. The rotation-in side first fixing portions 67a, 67b are disposed apart from each other in the axial direction.

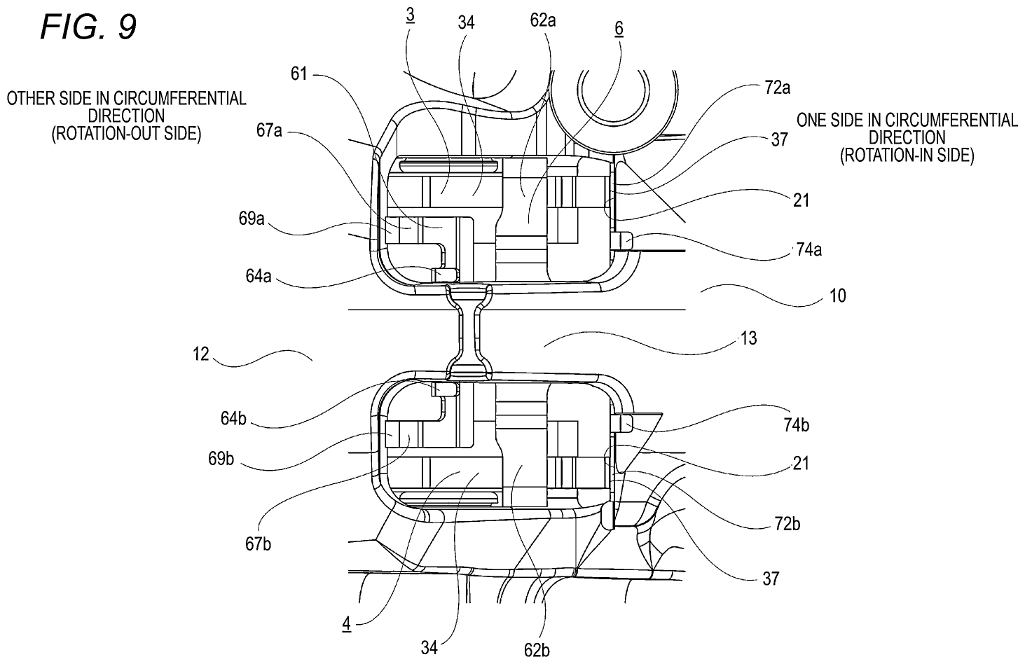

As illustrated in FIG. 9, the rotation-in side first fixing portions 67a, 67b are disposed on both sides of the rotation-in side circumferential bridge 13 in the axial direction in the state where the rotation-in side pad clip 6 is assembled to the caliper 2.

The rotation-in side first fixing portions 67a, 67b have rotation-in side first fold-back portions 69a, 69b at distal end portions. The rotation-in side first fold-back portions 69a, 69b are formed by folding back the distal end portions of the rotation-in side first fixing portions 67a, 67b toward the radially inner side and toward the one side in the circumferential direction by about 140 degrees. Side surfaces of the rotation-in side first fold-back portions 69a, 69b on the other side in the circumferential direction are formed by convex curved surfaces.

The rotation-in side second fixing portion 68 includes a circumferential connecting plate portion 70 that extends in a direction toward the radially inner side from the end portion of the rotation-in side substrate portion 66 on the one side in the circumferential direction as approaching the one side in the circumferential direction, and an axially protruding portion 71 in which an end portion of the circumferential connecting plate portion 70 on the radially inner side is connected to an axial intermediate portion of the axially protruding portion 71.

The axially protruding portion 71 has a substantially L-shape in the axial view. The axially protruding portions 71 protrude to the both axially outer sides from the circumferential connecting plate portion 70. The axially protruding portion 71 includes the pair of clamped plate portions 72a, 72b and a rotation-in side radial engagement portion 73.

The clamped plate portions 72a, 72b each have a flat plate shape, and are disposed apart from each other in the axial direction. The clamped plate portions 72a, 72b rise in the radial direction, and are provided to end portions on both axially outer sides of the axially protruding portion 71.

As illustrated in FIG. 7, in the state where the rotation-in side pad clip 6 is assembled to the caliper 2, the clamped plate portions 72a, 72b press the torque receiving surface 21 provided at the rotation-in side end bridge 10 in the circumferential direction to cover the torque receiving surface 21. In the state where the inner pad 3 and the outer pad 4 are assembled to the caliper 2, each of the clamped plate portions 72a, 72b is disposed between the torque receiving surface 21 and the torque transmission surface 37 provided at the back plate 34.

The rotation-in side radial engagement portion 73 protrudes from an axial intermediate portion of the axially protruding portion 71 toward the one side in the circumferential direction. The rotation-in side radial engagement portion 73 has an inverted V shape in the axial view.

As illustrated in FIG. 6, in the state where the rotation-in side pad clip 6 is assembled to the caliper 2, the rotation-in side radial engagement portion 73 is disposed on the radially inner side of the end portion of the rotation-in side end bridge 10 on the other side in the circumferential direction. The rotation-in side radial engagement portion 73 presses a radially inner side surface of the rotation-in side end bridge 10 toward the radially outer side. Accordingly, a position in the radial direction of the end portion of the rotation-in side pad clip 6 on the one side in the circumferential direction is restricted.

### <<Rotation-In Side Pad Pressing Portion>>

The rotation-in side pad pressing portions 62a, 62b press the inner pad 3 and the outer pad 4 to stabilize the postures of the inner pad 3 and the outer pad 4 in the non-braking state.

The pair of rotation-in side pad pressing portions 62a, 62b are disposed on both sides of the rotation-in side substrate portion 66 in relation to the axial direction, and are connected to the end portions on both sides of the rotation-in side substrate portion 66 in the axial direction.

The rotation-in side pad pressing portions 62a, 62b each have a lateral U-shape as viewed in the circumferential direction, extend toward the axially outer side from the rotation-in side substrate portion 66, and are folded back by about 180 degrees toward the radially inner side and toward the axially inner side from respective intermediate portions.

Front half portions of the rotation-in side pad pressing portions 62a, 62b are inclined in a direction toward the radially inner side as approaching the axially inner side in a free state.

As illustrated in FIG. 9, in the state where the rotation-in side pad clip 6 is assembled to the caliper 2, the rotation-in side pad pressing portions 62a, 62b are disposed on both sides of the rotation-in side circumferential bridge 13 in relation to the axial direction.

When the inner pad 3 and the outer pad 4 are assembled, the rotation-in side pad pressing portions 62a, 62b are pressed toward the radially outer side by the outer circumferential edges of the back plates 34, and are elastically deformed (resiliently deformed) in the radial direction. Accordingly, portions on the one side in the circumferential direction of the outer circumferential edge portions of the back plates 34 are pressed toward the radially inner side and toward the axially outer side.

### <<Circumferential Pressing Portion>>

The circumferential pressing portions 63a, 63b extend toward the radially inner side from the end portions on both sides in the axial direction of the axially protruding portion 71 forming the rotation-in side second fixing portion 68. The circumferential pressing portions 63a, 63b each have a band plate shape extending in the radial direction. The circumferential pressing portions 63a, 63b are spaced apart from each other in the axial direction and are disposed substantially parallel to each other.

When the inner pad 3 and the outer pad 4 are assembled, the circumferential pressing portions 63a, 63b are pressed in the circumferential direction by the side surfaces of the back plates 34 on the one side in the circumferential direction and are elastically deformed (resiliently deformed), and press the side surfaces of the back plates 34 on the one side in the circumferential direction toward the other side in the circumferential direction.

Accordingly, in the non-braking state, an outer peripheral surface of the pin 20 abuts against a side surface on the one side in the circumferential direction of an inner circumferential surface of the through hole 36. Accordingly, even when the brake tangential force F1 acts on the inner pad 3 and the outer pad 4 during the forward braking, the inner pad 3 and the outer pad 4 are prevented from moving to the other side in the circumferential direction, and the inner circumferential surface of the through hole 36 and the pin 20 are prevented from colliding with each other. As a result, generation of abnormal noise due to collision between the through hole 36 and the pin 20 is prevented.

### <<Rotation-In Side First Axial Restriction Portion>>

The rotation-in side first axial restriction portions 64a, 64b restrict the position of the rotation-in side pad clip 6 in the axial direction and prevent the inclination of the rotation-in side pad clip 6.

The rotation-in side first axial restriction portions 64a, 64b each have a substantially L-shape in the axial view, and are connected to both side portions in the axial direction of the end portion of the rotation-in side substrate portion 66 on the other side in the circumferential direction. Therefore, the rotation-in side first axial restriction portions 64a, 64b are disposed apart from each other in the axial direction, and are disposed between the pair of rotation-in side first fixing portions 67a, 67b in relation to the axial direction.

In the rotation-in side first axial restriction portions 64a, 64b, the portions connected to the rotation-in side first fixing portions 67a, 67b on the radially inner side extend in a direction toward the radially outer side as approaching the other side in the circumferential direction, and are disposed substantially parallel to base end side portions of the rotation-in side first fixing portions 67a, 67b.

Distal end portions (end portions on the radially outer side) of the rotation-in side first axial restriction portions 64a, 64b are bent by about 90 degrees with respect to the portions of the rotation-in side first axial restriction portions 64a, 64b on the radially inner side, and extend toward the radially outer side and toward the one side in the circumferential direction.

As illustrated in FIG. 9, in the state where the rotation-in side pad clip 6 is assembled to the caliper 2, the rotation-in side first axial restriction portions 64a, 64b are disposed on both sides of the rotation-in side circumferential bridge 13 in relation to the axial direction, and closely face both side surfaces of the rotation-in side circumferential bridge 13 in the axial direction.

The position in the axial direction of the portion on the other side in the circumferential direction of the rotation-in side pad clip 6 is restricted by the rotation-in side first axial restriction portions 64a, 64b abutting against the side surfaces of the rotation-in side circumferential bridge 13 in the axial direction.

Similarly to the case illustrated in FIG. 41, when the inner pad 3 (or outer pad 4) is assembled, even in a case where the one rotation-in side pad pressing portion 62a (62b) is pressed on the radially outer side by the outer circumferential edge portion of the back plate 34, the one rotation-in side first axial restriction portion 64a (64b) abuts against the side surface of the rotation-in side circumferential bridge 13 in the axial direction. Accordingly, the rotation-in side pad clip 6 is prevented from such an inclination that the portion on the one side in the axial direction is raised on the radially outer side and the portion on the other side in the axial direction is lowered on the radially inner side.

### <<Rotation-In Side Radial Restriction Portion>>

The rotation-in side radial restriction portion 65 restricts the position of the rotation-in side pad clip 6 in the radial direction.

The rotation-in side radial restriction portion 65 has a flat plate shape and is connected to the axial intermediate portion of the end portion of the rotation-in side substrate portion 66 on the other side in the circumferential direction. Therefore, the rotation-in side radial restriction portion 65 is disposed between the pair of rotation-in side first axial restriction portions 64a, 64b in relation to the axial direction. The rotation-in side radial restriction portion 65 is disposed substantially parallel to the rotation-in side substrate portion 66.

The rotation-in side radial restriction portion 65 abuts against the radially inner side surface of the rotation-in side circumferential bridge 13 in the state where the rotation-in side pad clip 6 is assembled to the caliper 2. Accordingly, a position in the radial direction of the end portion of the rotation-in side pad clip 6 on the other side in the circumferential direction is restricted.

### <<Rotation-In Side Second Axial Restriction Portion>>

The rotation-in side second axial restriction portions 74a, 74b restrict the position of the rotation-in side pad clip 6 in the axial direction.

As illustrated in FIG. 9, the rotation-in side second axial restriction portions 74a, 74b closely face both side surfaces of the rotation-in side circumferential bridge 13 in the axial direction. The rotation-in side second axial restriction portions 74a, 74b are provided at end portions of the clamped plate portions 72a, 72b on the axially inner side. The rotation-in side second axial restriction portions 74a, 74b each have a substantially L-shape in the axial view, extend toward the radially outer side from the clamped plate portions 72a, 72b, and are bent at a substantially right angle toward the one side in the circumferential direction from the end portion on the radially outer side.

The position in the axial direction of the portion of the rotation-in side pad clip 6 on the one side in the circumferential direction is restricted by the rotation-in side second axial restriction portions 74a, 74b abutting against the side surfaces of the rotation-in side circumferential bridge 13 in the axial direction.

According to the rotation-out side pad clip 5 of the present embodiment as described above, the rotation-out side pad clip 5 can be applied to the disc brake device 1 including the rotation-out side circumferential bridge 14, and a pressing force can be stably applied to the pair of pads 3 and 4.

The rotation-out side pad clip 5 of the present embodiment includes the main body portion 39 elastically supported between the central bridge 12 and the rotation-out side end bridge 11, and the pair of pad pressing portions 40a, 40b that press the outer circumferential edge portions of the back plates 34 of the inner pad 3 and the outer pad 4 toward the radially inner side, and the radially outer side surface of the main body portion 39 is pressed against the radially inner side surface of the rotation-out side circumferential bridge 14 by an elastic force of the pair of pad pressing portions 40a, 40b.

As described above, since the main body portion 39 elastically supported between the central bridge 12 and the rotation-out side end bridge 11 is disposed on the radially inner side of the rotation-out side circumferential bridge 14, the rotation-out side pad clip 5 of the present embodiment can be applied to the disc brake device 1 including the rotation-out side circumferential bridge 14.

Furthermore, since the radially outer side surface of the main body portion 39 is pressed against the radially inner side surface of the rotation-out side circumferential bridge 14, the rotation-out side circumferential bridge 14 can support the reaction forces of the pad pressing portions 40a, 40b. Therefore, the pressing force can be stably applied to the inner pad 3 and the outer pad 4 by the pad pressing portions 40a, 40b. Specifically, when the inner pad 3 and the outer pad 4 are assembled into the caliper 2, portions of the first clip 41 other than the pad pressing portions 40a, 40b do not have to be elastically deformed, and thus the pad pressing portions 40a, 40b can apply pressing forces having desired magnitude to the inner pad 3 and the outer pad 4.

In the present embodiment, since the radially outer side surface of the substrate portion 45 forming the main body portion 39 is in surface contact with the pressed surface 32 provided at the rotation-out side circumferential bridge 14, the position of the main body portion 39 in the radial direction can be strictly regulated, and the pressing forces applied by the pad pressing portions 40a, 40b can be more stabilized.

In the present embodiment, since the pad pressing portions 40a, 40b each have a lateral U-shape as viewed in the circumferential direction and are disposed on both sides of the main body portion 39 in relation to the axial direction, a total length of the pad pressing portions 40a, 40b can be shortened. Therefore, it is possible to reduce a weight and cost of the rotation-out side pad clip 5.

In the present embodiment, the rotation-out side pad clip 5 includes the first clip 41 having the main body portion 39 and the pair of pad pressing portions 40a, 40b, and the second clip 42 assembled to the rotation-out side end bridge 11, and thus the first clip 41 and the second clip 42 can exhibit different functions. Specifically, in the present embodiment, the first clip 41 can exert the function of pressing the inner pad 3 and the outer pad 4 toward the radially inner side, and the second clip 42 can exert the function of reducing the drag resistance of the inner pad 3 and the outer pad 4.

In the present embodiment, the second clip 42 includes the interposed portion 52 disposed between the second fixing portion 47 provided at the first clip 41 and the rotation-out side pressed surface 24 provided at the rotation-out side end bridge 11. When the second fixing portion 47 of the first clip 41 is brought into direct contact with the rotation-out side pressed surface 24, it is difficult to directly fix the second fixing portion 47 to the rotation-out side pressed surface 24 because the rotation-out side pressed surface 24 has a slope for exit of the casting. In the present embodiment, since the first clip 41 and the second clip 42 are formed separately, the second fixing portion 47 of the first clip 41 can be reliably engaged with the interposed portion 52 of the second clip 42.

The inner side clamping portion 54 forming the second clip 42 has the circumferential engagement portion 59, which is engaged, in the circumferential direction, with the engagement inclination surface 26 provided at the rotation-out side end bridge 11, at a portion protruding toward the other side in the circumferential direction from the outer side clamping portions 53a, 53b, and thus the outer side clamping portions 53a, 53b can be prevented from floating up from the moment supporting surface 23. Therefore, the drag resistance of the inner pad 3 and the outer pad 4 can be reduced, and the contact between the outer side clamping portions 53a, 53b and the moment supporting surface 23 can be stabilized to prevent the generation of the abnormal noise.

In the present embodiment, the inclination angle of the engagement inclination surface 26 with respect to the moment supporting surface 23 is restricted to 15 degrees or more and 30 degrees or less, and thus the outer side clamping portions 53a, 53b can be effectively prevented from floating up from the moment supporting surface 23.

In the present embodiment, since the second fixing portion 47 of the first clip 41 is engaged, in the axial direction, with the axial engagement portion 56 provided at the second clip 42, the position of the second fixing portion 47 in the axial direction can be restricted by using the second clip 42.

Since the first clip 41 includes the first axial restriction portions 43a, 43b disposed to closely face both side surfaces of the rotation-out side circumferential bridge 14 in the axial direction, it is possible to restrict the position in the axial direction of the portion of the first clip 41 on the one side in the circumferential direction by using the rotation-out side circumferential bridge 14, and to prevent the inclination of the first clip 41.

In the present embodiment, since the second clip 42 also includes the second axial restriction portions 55a, 55b disposed to closely face both side surfaces of the rotation-out side circumferential bridge 14 in the axial direction, the position of the second clip 42 in the axial direction can be restricted by using the rotation-out side circumferential bridge 14.

Since the first clip 41 includes the radial restriction portion 44 abutting against the radially inner side surface of the rotation-out side circumferential bridge 14 when the first clip 41 is assembled to the caliper 2, it is possible to prevent the abutting positions of the first fold-back portions 50a, 50b of the first fixing portions 46a, 46b with respect to the center side pressed surfaces 27 provided at the central bridge 12 from being displaced toward the radially outer side from the normal positions.

Since front half portions of the pad pressing portions 40a, 40b provided at the first clip 41 are inclined in a direction toward the radially inner side as approaching the axially inner side in a free state, the lining 33 can be separated from the rotor 7 during the non-braking. Therefore, the drag of the inner pad 3 and the outer pad 4 can be prevented.

In the present embodiment, since the rotation-in side pad clip 6 includes the rotation-in side first axial restriction portions 64a, 64b on the end portion on the other side in the circumferential direction and the rotation-in side second axial restriction portions 74a, 74b on the end portion on the one side in the circumferential direction, the position of the rotation-in side pad clip 6 in the axial direction can be restricted by using the rotation-in side circumferential bridge 13.

Since the rotation-in side pad clip 6 has a substantially L-shape in the axial view and includes the rotation-in side first axial restriction portions 64a, 64b disposed to closely face both side surfaces of the rotation-in side circumferential bridge 13 in the axial direction, it is possible to prevent the inclination of the rotation-in side pad clip 6.

### Second Embodiment

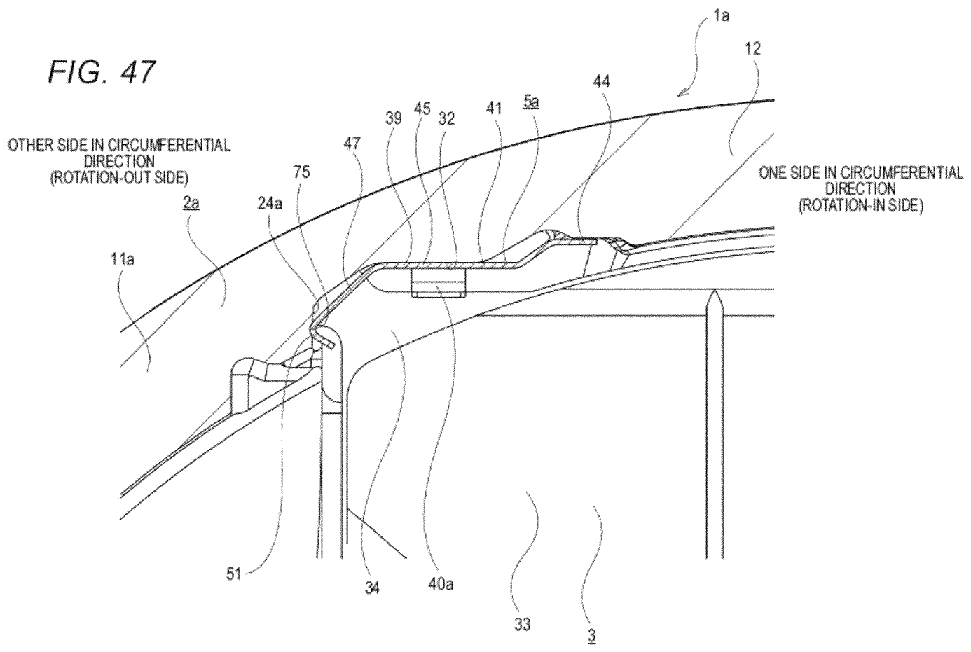

A second embodiment of the present disclosure will be described with reference to FIG. 47.

A disc brake device 1a of the present embodiment includes a rotation-out side pad clip 5a including only the first clip 41.

Therefore, the rotation-out side pad clip 5a of the present embodiment has a function of elastically pressing the inner pad 3 and the outer pad 4 toward the radially inner side to push back the inner pad 3 and the outer pad 4 in the axial direction.

A configuration of the first clip 41 forming the rotation-out side pad clip 5a is the same as the configuration of the first clip 41 forming the rotation-out side pad clip 5 of the first embodiment.

However, in the present embodiment, the second fold-back portion 51 provided at the distal end portion of the second fixing portion 47 forming the first clip 41 directly presses a rotation-out side end bridge 11a forming a caliper 2a in the circumferential direction. Specifically, the second fold-back portion 51 directly presses a rotation-out side pressed surface 24a provided at a portion, located on the radially inner side of the connection portion with the rotation-out side circumferential bridge 14, of a side surface of the rotation-out side end bridge 11a on the one side in the circumferential direction.

The rotation-out side end bridge 11a includes an engagement recessed portion 75 recessed toward the other side in the circumferential direction in a portion, pressed by the second fold-back portion 51 of the second fixing portion 47, of the rotation-out side pressed surface 24a.

The second fold-back portion 51 and the engagement recessed portion 75 are engaged with each other in the radial direction. Therefore, the position (abutting position) of the second fold-back portion 51 in the radial direction is prevented from being displaced toward the radially inner side.

In the case of the rotation-out side pad clip 5a of the present embodiment as described above, the main body portion 39 elastically supported between the central bridge 12 and the rotation-out side end bridge 11a is disposed on the radially inner side of the rotation-out side circumferential bridge 14, and thus the rotation-out side pad clip 5a can also be applied to the disc brake device 1a including the rotation-out side circumferential bridge 14. Since the radially outer side surface of the main body portion 39 is pressed against the radially inner side surface of the rotation-out side circumferential bridge 14 by the elastic forces of the pair of pad pressing portions 40a, 40b, it is possible to stably apply the pressing force to the inner pad 3 and the outer pad 4 by the pad pressing portions 40a, 40b.

Other configurations, operations, and effects of the second embodiment are the same as those of the first embodiment.

As described above, the pad clip for a disc brake device according to the aspect of the present disclosure can be applied to a disc brake device including a circumferential bridge, and can stably apply a pressing force to a pair of pads.

Although the embodiments according to aspects of the present disclosure have been described above, the present invention is not limited thereto, and can be appropriately changed without departing from the technical concept of the invention.

The structure of the pad clip of the present invention is not limited to the structure of each embodiment, and can be appropriately changed.

What is claimed is:

1. A pad clip for a disc brake device, the pad clip being made of a metal plate and being configured to elastically press a pair of pads and configured to be attached to a caliper including an inner body, an outer body, a central bridge and an end bridge which are disposed apart from each other in a circumferential direction and which respectively connect the inner body and the outer body in an axial direction, and a circumferential bridge which is hung between the central bridge and the end bridge in the circumferential direction, the pad clip comprising:
a main body portion elastically supported between the central bridge and the end bridge; and
a pair of pad pressing portions configured to press outer circumferential edge portions of the pair of pads toward a radially inner side, wherein
a radially outer side surface of the main body portion is configured to be pressed against a radially inner side surface of the circumferential bridge by an elastic force of the pair of pad pressing portions.

2. The pad clip for the disc brake device according to claim 1, wherein
the main body portion includes,
at an end portion on one side in a circumferential direction, two first fixing portions configured to press, in the circumferential direction, portions located on both sides with a connection portion with the circumferential bridge sandwiched in relation to the axial direction, of a side surface of the central bridge on the other side in a circumferential direction, and
at an end portion on the other side in the circumferential direction, a second fixing portion configured to directly or indirectly press, in the circumferential direction, a portion located at the radially inner side of the connection portion with the circumferential bridge, of a side surface of the end bridge on the one side in the circumferential direction.

3. The pad clip for the disc brake device according to claim 1, wherein
the pair of pad pressing portions are disposed on both sides of the main body portion in relation to the axial direction, and each have a lateral U-shape when viewed in the circumferential direction.

4. The pad clip for the disc brake device according to claim 2, further comprising:
a first clip including the main body portion and the pair of pad pressing portions; and
a second clip configured to be assembled to the end bridge, wherein
the second clip includes an interposed portion configured to be disposed between the second fixing portion and the side surface of the end bridge on the one side in the circumferential direction, and
the interposed portion includes a radial engagement portion configured to be engaged with the second fixing portion in a radial direction.

5. The pad clip for the disc brake device according to claim 4, wherein
the second fixing portion has a shape bent to be convex on the other side in the circumferential direction,
the radial engagement portion has a shape bent to be convex on the one side in the circumferential direction, and
the second fixing portion is disposed on a radially outer side of the radial engagement portion.

6. The pad clip for the disc brake device according to claim 5, wherein
the second clip is configured to be assembled to the end bridge on a rotation-out side, and includes two outer side clamping portions and one inner side clamping portion that are configured to elastically clamp the end bridge from both sides in the radial direction, and
the outer side clamping portions each have a flat plate shape, are configured to be disposed on both sides of the circumferential bridge in relation to the axial direction, and are configured to be clamped between a radially outer side surface of the end bridge and the pad.

7. The pad clip for the disc brake device according to claim 6, wherein
the inner side clamping portion includes, at a portion protruding to the other side in the circumferential direction from the outer side clamping portions, a circumferential engagement portion that is bent to be convex on the radially outer side and that is configured to be engaged with a radially inner side surface of the end bridge in the circumferential direction.

8. The pad clip for the disc brake device according to claim 4, wherein
the second clip includes a pair of second axial restriction portions configured to be disposed to closely face both side surfaces of the circumferential bridge in the axial direction.

9. The pad clip for the disc brake device according to claim 4, wherein
the second clip has a width in the axial direction slightly larger than a width of the second fixing portion in the axial direction, and has an axial engagement portion configured to be engaged with the second fixing portion in the axial direction.

10. The pad clip for the disc brake device according to claim 4, wherein
the first clip includes a pair of first axial restriction portions configured to be disposed to closely face both side surfaces of the circumferential bridge in the axial direction.

11. The pad clip for the disc brake device according to claim 4, wherein
the first clip includes a radial restriction portion that is configured to abut against the radially inner side surface of the circumferential bridge to prevent an abutting position of each of the first fixing portions with respect to the side surface of the central bridge on the other side in the circumferential direction from being displaced toward the radially outer side from a normal position, when the first clip is assembled to the caliper.

12. The pad clip for the disc brake device according to claim 1, wherein
the pair of pad pressing portions are configured to press the pads in a direction away from a rotor in relation to the axial direction.

13. A disc brake device comprising:
a caliper including an inner body and an outer body disposed on both sides in an axial direction with a rotor sandwiched, a central bridge and an end bridge which are disposed apart from each other in a circumferential direction and which respectively connect the inner body and the outer body in the axial direction, and a circumferential bridge which is hung between the central bridge and the end bridge in the circumferential direction;
a pair of pads supported in a manner of being movable in the axial direction with respect to the caliper; and
a pad clip made of a metal plate, configured to elastically press the pair of pads, and attached to the caliper, wherein
the pad clip is the pad clip for the disc brake device according to claim 1.

14. The disc brake device according to claim 13, wherein
the end bridge has, on a radially inner side surface, an engagement inclination surface that is inclined in a direction toward the radially inner side as approaching one side in a circumferential direction and that is engaged with a circumferential engagement portion in the circumferential direction,
in the pad clip, the main body portion includes,
at an end portion on one side in a circumferential direction, two first fixing portions configured to press, in the circumferential direction, portions located on both sides with a connection portion with the circumferential bridge sandwiched in relation to the axial direction, of a side surface of the central bridge on the other side in a circumferential direction, and
at an end portion on the other side in the circumferential direction, a second fixing portion configured to directly or indirectly press, in the circumferential direction, a portion located at the radially inner side of the connection portion with the circumferential bridge, of a side surface of the end bridge on the one side in the circumferential direction,
the pad clip further comprises:
a first clip including the main body portion and the pair of pad pressing portions; and
a second clip configured to be assembled to the end bridge,
the second clip includes an interposed portion configured to be disposed between the second fixing portion and the side surface of the end bridge on the one side in the circumferential direction,
the interposed portion includes a radial engagement portion configured to be engaged with the second fixing portion in a radial direction,
the second fixing portion has a shape bent to be convex on the other side in the circumferential direction,
the radial engagement portion has a shape bent to be convex on the one side in the circumferential direction,
the second fixing portion is disposed on a radially outer side of the radial engagement portion,
the second clip is configured to be assembled to the end bridge on a rotation-out side, and includes two outer side clamping portions and one inner side clamping portion that are configured to elastically clamp the end bridge from both sides in the radial direction,
the outer side clamping portions each have a flat plate shape, are configured to be disposed on both sides of the circumferential bridge in relation to the axial direction, and are configured to be clamped between a radially outer side surface of the end bridge and the pad, and
the inner side clamping portion includes, at a portion protruding to the other side in the circumferential direction from the outer side clamping portions, the circumferential engagement portion that is bent to be convex on the radially outer side and that is configured to be engaged with a radially inner side surface of the end bridge in the circumferential direction.

15. The disc brake device according to claim 14, wherein
the end bridge has a planar moment supporting surface configured to be in surface contact with the outer side clamping portions on the radially outer side surface, and
an inclination angle of the engagement inclination surface with respect to the moment supporting surface is 15 degrees or more and 30 degrees or less.

16. The disc brake device according to claim 13, wherein
a second fixing portion is configured to directly press, in the circumferential direction, a portion located on a radially inner side of a connection portion with the circumferential bridge, of a side surface of the end bridge on one side in a circumferential direction,
the end bridge has an engagement recessed portion recessed toward the other side in a circumferential direction at a portion configured to be pressed by the second fixing portion, of the side surface on the one side in the circumferential direction, and
in the pad clip, the main body portion includes,
at an end portion on one side in a circumferential direction, two first fixing portions configured to press, in the circumferential direction, portions located on both sides with a connection portion with the circumferential bridge sandwiched in relation to the axial direction, of a side surface of the central bridge on the other side in a circumferential direction, and
at an end portion on the other side in the circumferential direction, the second fixing portion configured to directly or indirectly press, in the circumferential direction, a portion located at the radially inner side of the connection portion with the circumferential bridge, of a side surface of the end bridge on the one side in the circumferential direction.

17. The disc brake device according to claim 13, wherein
a side surface of the central bridge on the other side in a circumferential direction has, at a radially inner side portion, a first inclination surface that is inclined in a direction toward the other side in the circumferential direction as approaching a radially outer side, and has, at a portion adjacent to the radially outer side of the first inclination surface, a second inclination surface that is inclined in a direction toward one side in a circumferential direction as approaching the radially outer side.
